(19) United States
(12) Patent Application Publication
(10) Pub. No.: US 2024/0185111 A1
(43) Pub. Date: Jun. 6, 2024

(54) EFFICIENT SAMPLING SYSTEM AND METHD OF GROUND-STATEAND LOW-ENERGY ISING SPIN CONFIGURATIONS WITH A COHERENT ISSING MACHING

(71) Applicants: NTT RESEARCH, INC., Sunnyvale, CA (US); STANFORD UNIVERSITY, Stanford, CA (US)

(72) Inventors: Edwin NG, Stanford, CA (US); Tatushiro ONODERA, Sunnyvale, CA (US); Satoshi KAKO, Sunnyvale, CA (US); Yoshihisa MAMOTO, Sunnyvale, CA (US)

(73) Assignees: NTT RESEARCH, INC., Sunnyvale, CA (US); STANFORD UNIVERSITY, Stanford, CA (US)

(21) Appl. No.: 18/548,799

(22) PCT Filed: Mar. 4, 2022
(86) PCT No.: PCT/US2022/019036

§ 371 Date: Sep. 1, 2023

Related U.S. Application Data
(60) Provisional application No. 63/157,673, filed on Mar. 6, 2021.

(51) Int. Cl. G06N 10/20; G06N 7/01

(52) U.S. Cl. CPC G06N 10/20; G06N 7/01

(57) ABSTRACT

A system and method for efficient sampling of ground-state and low-energy Ising configurations. The system may be implemented using the nonlinear stochastic dynamics of a measurement-feedback-based coherent Ising machine (MFB-CIM). A discrete-time Gaussian-state model of the MFB-CIM may capture the nonlinear dynamics. The system and method requires many fewer roundtrips to sample than for other known systems.

### CROSS REFERENCE

This application claims priority from U.S. Provisional application 63/157,673 filed 6 Mar. 2021, the entirety of which is hereby incorporated by reference.

### APPENDICES

Appendices A and B (2 pages) has details of the quadratic equations or motion for crystal propagation and details of evaluating expectation values of quadratic operators.

Each appendix above forms part of the specification and incorporated herein.

### FIELD

The disclosure relates generally to a system and method for efficient sampling of ground-state and low-energy Ising spin configurations and in particular to a system and method that uses a coherent Ising machine to perform the efficient sampling of ground-state and low-energy Ising spin configurations.

### BACKGROUND

For decades, the Ising model has served as a key conceptual bridge between the fields of physics and computation. A host of important combinatorial optimization problems have efficient mappings to the problem of finding ground states of the Ising model [1], while the simple and highly generic form of the model means that Ising-like interactions are ubiquitious across a diverse array of systems [2]. Formally, the Ising model consists of a set of spins σᵢ=±1 with configuration energy given by the Ising Hamiltonian: Σ_{i≠j}Jᵢⱼσᵢσⱼ and, in general, the Ising problem of finding spin configurations that minimize this energy is presently intractable on conventional computers [3]. As a result, significant interest has developed towards leveraging physical Ising-like systems as special-purpose computational hardware for tackling problems such as combinatorial optimization, with ongoing research on platforms ranging from quantum annealers built from microwave superconducting circuits [4, 5] to coherent Ising machines [6, 9] based on networks of nonlinear optical oscillators among many others [10, 15].

But while combinatorial optimization is often focused on finding just one of the ground-state Ising spin configurations, it is desirable in many applications to obtain many or all degenerate ground-state configurations, and, in some cases, to sample many low-energy configurations as well [16]. Such sampling capability is particularly useful for applications that involve obtaining distributional information about spin configurations in an Ising model, such as estimating the ground-state entropy of a physical simulation with Ising-like interactions or implementing Boltzmann machines as generative models for machine learning [17, 19]. In industrial settings, accessing a pool of candidate solutions to an optimization problem can make processes more efficient and flexible; for example in drug discovery [20, 23], structure-based lead optimization could generate a number of candidate molecules for simultaneous testing. Recently, it has also been pointed out [24, 25] that when decomposing large optimization problems into subproblems to be solved separately (e.g., to accommodate hardware limitations), better solutions to the original problem can be constructed using multiple low-energy samples rather than just the optimum for each subproblem. However, an Ising solver designed for combinatorial optimization is not necessarily well-suited to sample all ground states and/or low-energy states. For instance, although the commercial quantum annealers by D-Wave Systems have shown success in finding ground states of the Ising problem, their principle of operation can lead to an exponential bias in the distributions of degenerate ground-state samples [26, 28].

Thus, it is desirable to provide a system for method for efficient sampling of ground states and low energy CIM states that resolves the above limitations and problems of the prior techniques and it is to this end that the disclosure is directed.

### BRIEF DESCRIPTION OF THE DRAWINGS

FIG. 1 shows a measurement-feedback coherent Ising Machine (MFB-CIM);

FIGS. 2A and 2B illustrate how quantum noise can influence the nonlinear dynamics of CIM;

FIG. 3 illustrates trajectories of the discrete-time model for various cavity decay times;

FIG. 4 shows the MFB-CIM sampling for low-energy spin configurations for a specific N=15 Ising problem;

FIG. 5 shows the variation of a maximum required sampling time for the pin configurations shown in FIG. 4;

FIG. 6 shows the scaling of time required to sample a single Ising ground state as a function of cavity decay;

FIG. 7 shows the required sampling times for alternative MFB-CIM sampling models;

FIG. 8 illustrates the scaling of the sampling performance of a negative pump MFB-CIM for problem size N;

FIG. 9 shows the sampling performance with various alternative CIM sampling methods;

FIGS. 10A and 10B are a flowchart of the iterative method for efficient sampling; and

FIG. 11 illustrates a computer system that incorporates the CIM in FIG. 1 and may perform the efficient sampling.

### DETAILED DESCRIPTION OF ONE OR MORE EMBODIMENTS

The disclosure is particularly applicable to a system and method for efficiently sampling ground-states and low energy Ising spin configurations using a measurement feedback based coherent Ising machine (“MFB-CIM”) as disclosed and it is in this context that the disclosure will be described. It will be appreciated, however, that the system and method has greater utility since the system and method can be implemented using alternative embodiments and implementations as discussed in more detail below.

The system and method for efficient sampling of ground states and low energy spin configurations of Ising machine may be implemented using specifically configured measurement-feedback-based coherent Ising machine (MFB-CIM) [7, 9, 29]. The MFB-CIM is a hardware platform originally conceived for performing Ising optimization using a network of degenerate optical parametric oscillators (DOPOs) subject to a real-time measurement-feedback protocol which encodes Ising interactions into the network dynamics. In particular, the method uses a Gaussian-state model to examine how quantum noise arises within the dynamics of the MFB-CIM and to address whether such stochastic nonlinear dynamics can facilitate efficient sampling of low-energy Ising configurations. While a fully quantum treatment of the MFB-CIM is possible [29], numerical study of the large-scale systems relevant for combinatorial optimization/sampling is only possible up to the Gaussian-state regime where quantum correlations are considered only up to second order (i.e., up to covariances of observables) [30]. This Gaussian-state approximation is consistent with the operational regimes of all experimental MFB-CIMs known to date [7, 9], while still providing an accurate treatment of important quantum-noise-driven phenomena such as squeezing/anti-squeezing and measurement uncertainty and backaction [29, 31, 32] which are important to for the study of sampling performance but usually neglected in mean-field models.

The potential of MFB-CIMs to efficiently generate samples of degenerate ground- and low-energy-excited spin configurations was recently pointed out in Ref [33], using a Gaussian-state quantum model formulated in continuous time [34]. In the system and method, a continuous-time model correctly capture the dynamics of the MFB-CIM in the high-finesse limit where the cavity decay time of its constituent DOPOs dominate all other system timescales. On the other hand, the intrinsically higher bandwidth of a low-finesse cavity can, at least in principle, be leveraged to significantly reduce computational runtime; indeed, most experimental implementations of CIMs (both optically-coupled as well as measurement-feedback-based) utilize DOPOs operating in the low-finesse regime of short cavity decay times [6, 9]. Low-finesse systems are more conveniently described in discrete time, where dynamics occur via a sequence of discrete operations on the system state. Theoretically, such discrete-time models of the MFB-CIMs have been previously studied in Refs. [35, 36]. While the latter study used a non-Gaussian model for the quantum state which is only numerically tractable for small problem sizes, the former work used a Gaussian-state model to study the linear dynamics of the MFB-CIM. In this Gaussian model, however, the nonlinear gain saturation which can in principle play a non-negligible dynamical role in the MFB-CIM near and above threshold was only considered phenomenologically. To circumvent these limitations of the known techniques, the system and method uses a discrete-time Gaussian-state quantum model featuring a physical model for nonlinear gain saturation that can study low- and intermediate-finesse MFB-CIMs below, through, and above threshold.

### Gaussian Quantum Models of the Measurement-Feedback-Based CIM (MFB-CIM)

Conceptually, the coherent Ising machine (CIM) is a system of N degenerate optical parametric oscillators (DOPOs), which are nonlinear optical oscillators exhibiting saturable phase-sensitive gain. When pumped below its oscillation threshold, the state of a DOPO is well-described by a quadrature-squeezed state, while far above threshold, nonlinear saturation of the gain due to pump depletion stabilizes the system into one of two phase-bistable bright coherent states (referred to as the 0 and π phase states). To encode Ising spins into the DOPO network, the method associates these bistable phase states to the Ising spins=±1. By engineering the interactions among the DOPOs, the system with system dynamics which are dictated by a desired Ising coupling matrix J.

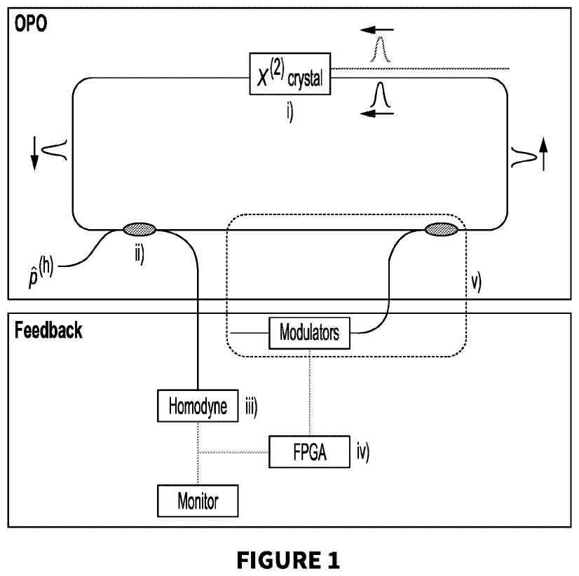

FIG. 1 depicts, on the schematic level, a measurement-feedback coherent Ising machine (MFB-CIM) that may be used in the disclosed system. In this MFB-CIM, the degenerate optical parametric oscillators (DOPOs) are realized as synchronously-pumped, time-multiplexed “signal” pulses in a single optical cavity, with pulse interactions mediated by a synchronous, real-time measurement-feedback protocol. The device consists of a system of DOPOs and a feedback control module as shown in FIG. 1. The OPO is pumped with a second harmonic pulse of light in a medium with second order (χ⁽²⁾) nonlinearity. Homodyne measurement of the intracavity pulse is taken by tapping out the intra-cavity pulse via a beam splitter operation with an incoming pulse with state ρ^{(h)}. The measured homodyne signal is fed to the FPGA which performs a matrix vector product. Finally, this output is used to apply a displacement on the intra-cavity pulse in the OPO. The Gaussian quantum model for the MFB-CIM models the physics of this device in discrete time by providing a theoretical description for every physical process, which are labelled by roman numerals, in the CIM.

In the measurement-feedback-based CIM (MFB-CIM) shown in FIG. 1, the signal pulses are separated by a time interval 1/=fᵣₑₚ; thus to fit N pulses, the cavity length is ≈Cn/fᵣₑₚ. On each round trip through the cavity, the signal pulses sequentially co-propagate through a nonlinear χ⁽²⁾ crystal alongside synchronous, externally injected pump pulses, imparting phase-sensitive amplification along the in-phase q-quadrature and phase-sensitive deamplification along the p-quadrature. Next, the signal pulses are also tapped out sequentially through an output coupler. The output is then measured on a q-quadrature homodyne detector, which results in an indirect and weak measurement of the q-quadrature amplitude of the internal signal pulse. Crucially, the sign configuration of the N homodyne measurements, say (sgn ω₁, . . . , sgn ω_{N}), constitute a sampled Ising spin configuration under the correspondence σ_{i↔}sgn ωᵢ. Finally, to implement the interactions between the pulses, the FPGA in FIG. 1 receives the homodyne results and computes an analog feedback signal υᵢ ∝ΣⱼJᵢⱼωⱼ which is applied to the corresponding ith signal pulse via synchronous external injection of a feedback pulse with intensity and phase determined by υᵢ (e.g., using synchronous optical modulators). The interference between the injected pulse and the internal signal pulse steers the system towards lower-energy Ising spin configurations, thus dynamically realizing the Ising coupling matrix J in the MFB-CIM system.

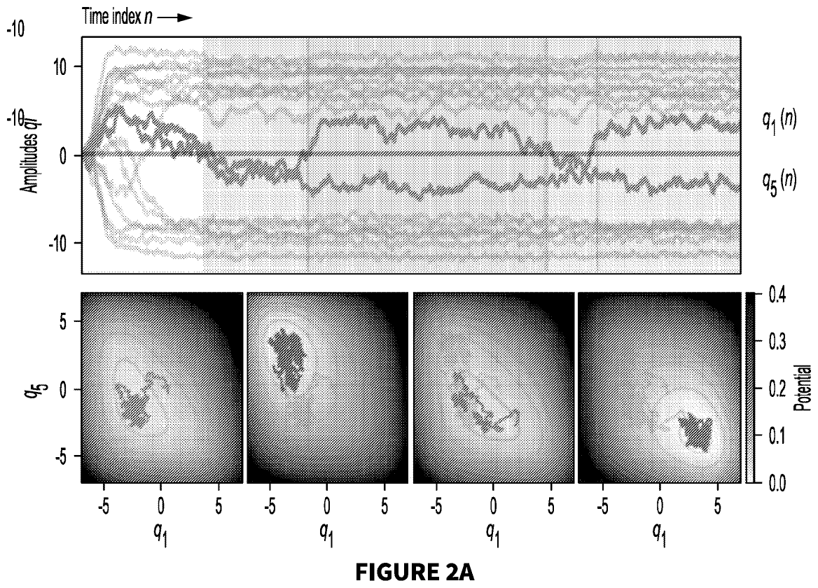

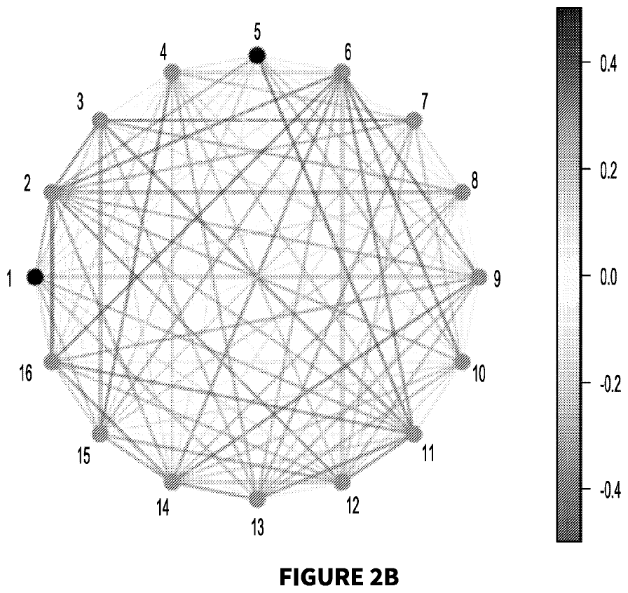

The result of embedding the structure of the Ising couplings into the system dynamics is that the evolution of the state is governed by the interplay of nonlinearity, which drives the signal amplitudes to bistable spin values; linear coupling, which drives the system towards collective configurations that minimize the Ising energy; and quantum noise, which arises from the inherent uncertainty of the weak homodyne measurement and drives the system via both measurement backaction and feed-back injection. As illustrated conceptually in FIG. 2, the dynamical evolution of the signal amplitudes is stochastic and nonlinear, with preferred sign configurations dictated by the Ising coupling matrix. In the continuous-time limit, a convenient and intuitive picture is to think of such stochastic trajectories as noisy gradient descent on a potential landscape: as the state evolves stochastically in time, the instantaneous potential seen by any given spin dynamically changes as well, guiding the system around and across local minima born out of the interplay between nonlinearity and coupling.

Open-dissipative bosonic systems like the MFB-CIM which have relatively weak single-photon-induced non-linearities and are subject to continuous homodyne measurement can usually be well-approximated by a Gaussian state. Formally, this means that its quantum state has a Wigner function that is approximately Gaussian and as a result can be fully characterized by simply specifying a set of mean-eld amplitudes and a set of covariances describing the quantum correlations and uncertainties of those amplitudes. Another very useful simplification which applies to MFB-CIMs is the fact that the pulses, while interacting through measurement feedback, are nevertheless unentangled since the physics in FIG. 1 only involve local operations and classical communication (LOCC) among the signal pulses, leading to zero covariances between different signal pulses.

Many of the operations involved in FIG. 1, including out-coupling, homodyne measurement, and feedback injection, are linear operations, and for Gaussian states, such operations have a particularly simple description if the method uses a discrete-map formalism for the dynamics in which it is assumed the signal pulses undergoes a discrete input-output transformation upon passing through each optical component. This discrete-map approach stands in contrast to more traditional continuous-time models in quantum optics, where the amplitudes evolve continuously in time under the action of an effective system Hamiltonian and a set of Liouvillian superoperators representing losses and measurements. Of course, the time-multiplexed, pulsed nature of the setup described in FIG. 1 lends itself naturally to a discrete-map model when the pulse widths are short compared to their separation. Nevertheless, a continuous-time model can be an appropriate approximation when the cavity finesse is high: in this limit, the single-roundtrip gain, loss, and measurement strengths are all small leading to small changes in the cavity state on every roundtrip, so the overall system dynamics are well-described by continuous-time differential equations. In order to study the impact of varying the cavity finesse on sampling performance, the method uses however, the more general framework of a discrete-time formalism where the linear loss can be specified independently of other parameters.

Crucially, the one operation in the MFB-CIM that does not easily lend itself to a discrete-time model is the propagation of the signal pulse through the crystal. Below threshold, this operation can be well-described by linear quantum-limited gain along the q-quadrature [31], and this is modelled as a discrete-time squeezing operation in Ref [35]. On the other hand, when the DOPO is near or above threshold, the co-propagating pump pulse becomes depleted, which saturates the gain and leads to nonlinear dynamics. The main contribution of the model that follows is to prescribe an efficient numerical treatment of this latter gain saturation physics, allowing the discrete-time model to be extended into the above-threshold regime while remaining consistent with standard continuous-time quantum optical models for the MFB-CIM in the high-finesse limit.

A formal description of the Gaussian-state model is set forth below which culminates in a complete iterative algorithm for simulating the MFB-CIM in discrete time. The disclosure also shows that in the limit of high finesse, the dynamics of this model exactly reduce to those of standard continuous-time quantum models used to treat MFB-CIMs in the Gaussian-state regime.

### Discrete-Time Gaussian Quantum Model

In this disclosure, the time-multiplexed MFB-CIM may be abstracted as an N-mode bosonic system with mode annihilation operators âₗ obeying [âₗ, a†ⱼ]=δᵢⱼ and quadrature operators \hat{z}=(\hat{q}₁, \hat{p}₁, . . . , \hat{q}_{N},p_{N} defined so that: [\hat{z}ₖ, [symbol] ]= [symbol] where

$$Ω = {⊕}_{i = 1}^{N} ( \begin{matrix}0 & 1 \\ - 1 & 0\end{matrix} )$$

is the symplectic form.

If the system is in a Gaussian state, it is fully determined by only a mean vector and a covariance matrix Σ; i.e., the quantum state can be written as \hat{ρ}(μ, Σ) where the first-order moment (i.e., mean vector) is:

μₖ=tr[\hat{z}ₖ\hat{ρ}(μ, Σ)] (1a)

and its second-order moment (i.e., covariance matrix) is

$${Σ}_{k ℓ} = tr [ \frac{1}{2} ( δ {\hat{z}}_{k} δ {\hat{z}}_{ℓ} + δ {\hat{z}}_{ℓ} δ {\hat{z}}_{k} ) \hat{ρ} ( μ , Σ ) ] \qquad ( 1 b )$$

where δ\hat{z}=\hat{z}−μ is a vector of fluctuation operators for each quadrature. Because the MFB-CIM is additionally unentangled due to LOCC dynamics, additional simplifications can be applied.

$$u = {{⊕}_{i = 1}}^{N} {μ}^{( i )} and Σ = {{⊕}_{i = 1}}^{N} {Σ}^{( i )} \qquad ( 2 a )$$

where, explicitly,

$${μ}^{( i )} = ( 〈 {\hat{q}}_{i} 〉 , 〈 {\hat{p}}_{i} 〉 ) \qquad ( 2 b )$$

$${Σ}^{( i )} = ( \begin{matrix}〈 δ {\hat{q}}_{i}^{2} 〉 & \frac{1}{2} 〈 δ {\hat{q}}_{i} δ {\hat{p}}_{i} + δ {\hat{p}}_{i} δ {\hat{q}}_{i} 〉 \\ \frac{1}{2} 〈 δ {\hat{q}}_{i} δ {\hat{p}}_{i} + δ {\hat{p}}_{i} δ {\hat{q}}_{i} 〉 & 〈 δ {\hat{q}}_{i}^{2} 〉\end{matrix} , ) \qquad ( 2 c )$$

so that, instead of having O(N²) entries in general, there are at most only 4N nonzero entries in the covariance matrix (and only 3N unique ones) for the MFB-CIM. Accordingly, the quantum state factorizes as

$$ρ ( μ , Σ ) = {{⊕}_{i = 1}}^{N} \hat{ρ} ( {μ}^{( i )} , {Σ}^{( i )} ) \qquad ( 2 d )$$

as expected. Note that for two vectors μ⁽¹⁾ and μ⁽²⁾, μ⁽¹⁾⊕μ⁽²⁾ denotes their concatenation while for two matrices Σ⁽¹⁾ and Σ⁽²⁾, Σ⁽¹⁾⊕Σ⁽²⁾ denotes the block diagonal matrix

$$( \begin{matrix}{Σ}^{( 1 )} & 0 \\ 0 & {Σ}^{( 2 )}\end{matrix} ) .$$

More generally, when two systems with states \hat{ρ}(μ^{(a)}, Σ^{(a)}) and \hat{ρ}(μ^{(b)}, Σ^{(b)}) are brought together, the joint system is described by the state

$$\begin{matrix}\hat{ρ} ( {μ}^{( a , b )} , {Σ}^{( a , b )} ) = \hat{ρ} ( {μ}^{( a )} , {Σ}^{( a )} ) ⊗ \hat{ρ} ( {μ}^{( b )} , {Σ}^{( b )} ) \\ = \hat{ρ} ( {μ}^{( a )} ⊕ {μ}^{( b )} , {Σ}^{( a )} ⊕ {Σ}^{( b )} )\end{matrix} . \qquad ( 3 )$$

On the other hand, if \hat{ρ}(μ^{(a,b)}, Σ^{(a,b)}) is a joint system of two modes, then mode b can be partially traced out by projecting out the subspace associated with mode b:

tr_{b}[\hat{ρ}(μ^{(a,b)}, Σ^{(a,b)})]=\hat{ρ}(Pμ^{(a,b)}, PΣ^{(a,b)}P^{T}) (4a)

where the projection matrix in this case is

$$P = ( \begin{matrix}1 & 0 & 0 & 0 \\ 0 & 1 & 0 & 0\end{matrix} ) \qquad ( 4 b )$$

### Linear Operations

Having established the basic formalism above, there are some linear operations that are necessary for the operation of the MFB-CIM before moving onto the nonlinear map. These elementary operations consist of beamsplitters for modelling loss and outcoupling, coherent injections for modelling feedback, and homodyne measurements.

A two-mode beamsplitter acting on a two-mode state \hat{ρ}(μ, Σ) with field-exchange amplitude r (i.e., power exchange ratio r²) can be described as

Bᵣ[\hat{ρ}(μ, Σ)]=\hat{ρ}(Sμ, SΣS^{T}) (5a)

with the beamsplitter matrix:

$$S = ( \begin{matrix}t & 0 & - r & 0 \\ 0 & t & 0 & - r \\ r & 0 & t & 0 \\ 0 & r & 0 & t\end{matrix} ) \qquad ( 5 b )$$

where t=\sqrt{1−r²} is the self-scattering amplitude.

A coherent injection of a displacement α ∈ [symbol] ² (representing the two quadratures of the displacement) into a mode a can be obtained by introducing a new mode b with a displaced mean α/ε and then applying a beam-splitter with field-exchange amplitude ε→0 to a and b. In this limit, the mode a does not inject into b, but since the mean of b goes α/ε, the overall displacement incurred by a goes to a constant in the limit:

$${𝒱}_{a} [ \hat{ρ} ( {μ}^{( a )} , {Σ}^{( a )} ) ] = {lim}_{ε \to 0} {tr}_{b} ( {ℬ}_{ϵ} [ \hat{ρ} ( {μ}^{( a )} , {Σ}^{( a )} ) ⊗ \hat{ρ} ( {ε}^{- 1} {α}^{( b )} , {Σ}_{0}^{( b )} ) ] )$$

where Σ₀=diag(1/2, 1/2) is the covariance of a coherent state. The result of this limit is simple, and (dropping the superscripts for simplicity) gives the expected result

[symbol]

_{α}[\hat{ρ}(μ, Σ)]=\hat{ρ}(μ+α, Σ) (6)

Finally, it is possible to make a q-quadrature measurement of a mode b in a two-mode system \hat{ρ}(μ^{(a,b)}, Σ^{(a,b)}) which can be written in the general form:

$${μ}^{( a , b )} = ( \begin{matrix}{μ}^{( a )} \\ {μ}^{( b )}\end{matrix} ) and {Σ}^{( a , b )} = ( \begin{matrix}{Σ}^{( a )} & V \\ {V}^{T} & {Σ}^{( b )}\end{matrix} )$$

where V captures the quantum correlation between the two modes. The measurement results in a random normally-distributed output

w˜ [symbol] (μ_{q}^{(b)}, Σ_{qq}^{(b)}) (7)

where μ_{q}^{(b)} and μ_{qq}^{(b)} (q simply denotes the first index) are the mean and variance of the q-quadrature of mode b, respectively. After the measurement is performed, the mode b is projected onto a \hat{q}_{b-eigenstate|q=w} [symbol] _{_{b}} and can be formally traced out. The appropriate back-action onto the mode α is described by the operation [38, 39]:

μ_{w}^{(a)}=μ^{(a)}+V(QΣ^{(b)}Q)⁺(w−μ^{(b)}) (8a)

Σ_{w}^{(a)}=Σ^{(a)}−V(QΣ^{(b)}Q)⁺V^{T} (8b)

where

$$Q = ( \begin{matrix}1 & 0 \\ 0 & 0\end{matrix} )$$

is the projector onto the q-quadrature of mode b and for any matrix M, M⁺ denotes its Moore-Penrose pseudo-inverse. That is, after obtaining the measurement result w, the state of mode a is \hat{ρ}(μ_{w}^{(a)}, Σ_{w}^{(a)}). An alternative, more explicit formula can be obtained for this simple two-mode case by writing V=(ν_{q} νₚ). Then, the pseudo-inverse may be computed analytically to get:

$${μ}_{w}^{( a )} = {μ}^{( a )} + ( \frac{w - {μ}_{q}^{( b )}}{{Σ}_{qq}^{( b )}} ) {v}_{q} \qquad ( 9 a )$$

$${Σ}_{w}^{( a )} = {Σ}^{( a )} - \frac{{v}_{q} {v}_{q}^{T}}{{Σ}_{qq}^{( b )}} \qquad ( 9 b )$$

The measurement plus back-action by the operation may be denoted by:

[symbol]

_{b}[\hat{ρ}(μ^{(a,b)}, Σ^{(a,b)})]=\hat{ρ}(μ_{w}^{(a)}, Σ_{w}^{(a)}) (10)

conditional on the measurement output w given by (7).

While these linear maps describing outcoupling, measurement, and feedback injection are fairly straightforward, dissipative linear losses also need to be addressed.

Experimental sources of loss in the physical CIM vary by implementation details, but some prominent sources include crystal facet losses (due to mode-matching inefficiency or Fresnel-reflection losses) and cavity propagation losses (due to scattering off mirrors or mode-matching inefficiency while coupling in/out of fibers). Since crystal facet losses generally dominate in realistic experimental implementations, the method assumes, for simplicity, that all loss mechanisms can be lumped together and applied via a pair of partial beamsplitters, placed before and after the crystal. Like the outcoupler used for measurement, these beamsplitters tap out intracavity light, but instead of the outgoing pulse being measured via homodyne (which would cause back-action on the state), this external pulse cannot be measured and simply partial trace it out instead, leading to dissipation on the state.

### Nonlinear Crystal Propagation

The most difficult part of the discrete-time model concerns the propagation of the pulse through the nonlinear crystal, which, as a dynamical non-Gaussian process, stands in contrast to the other operations, including measurement and feedback, that can all be ideally treated as Gaussian operations. For each incoming signal pulse âᵢ, a new pump pulse \hat{b} instantiated in a coherent state is injected into the optical path via a dichroic mirror to propagate simultaneously with the signal pulse, thus activating a parametric interaction between the signal and pump described by a Hamiltonian:

$${\hat{H}}_{nl} / ℏ = \frac{i ϵ}{2} ( \hat{b} {\hat{a}}_{i}^{†2} - {\hat{b}}^{†} {\hat{a}}_{i}^{2} ) \qquad ( 11 )$$

where the coupling rate c contributes (along with the crystal length, the amplitude of the initial pump pulse, etc.) to the overall small-signal parametric gain experienced by the signal pulse (thus determining, e.g., the DOPO threshold). The two-mode-interaction form of this Hamiltonian fundamentally assumes that the pulses are either sufficiently long in time to avoid walk-off or pulse distortion effects due to dispersion or that such dispersion has been well-managed, allowing both the signal and pump pulses to be abstracted as single-mode excitations of the field. In such a model, mode-matching inefficiencies (temporal, spectral, spatial, etc.) are all taken into account by the coupling rate.

In general, the Hamiltonian (11) can produce both entanglement and non-Gaussianity in the joint state between the pump and signal pulses, requiring the full joint Hilbert space of the two modes to describe properly. In order to make the crystal propagation compatible with the Gaussian formalism, we derive equations of motion (EOMs) for the Gaussian moments of the pump and signal pulses generated by (11), while assuming that the non-Gaussianity of the state (characterized by higher-order moments) remains negligible. This approximation is valid if the DOPOs have a large saturation photon number, i.e., a single photon only induces small gain saturation. The EOMs can then be numerically integrated from the input to the output facets of the crystal, resulting in a nonlinear map which can be abstractly written as:

χ:\hat{ρ}(μ⁽ⁱ⁾, Σ⁽ⁱ⁾)⊗\hat{ρ}(μ^{(b)}, Σ₀^{(b)}) [symbol] \hat{ρ}(μ^{(i,b)}, Σ^{(i,b)}) (12)

which acts on the incoming state (a Gaussian signal pulse unentangled with a coherent-state pump pulse) and produces a joint correlated pump-signal Gaussian state. After the crystal propagation is complete, the pump pulse is also addressed as it can, in general, be entangled with the signal. In the method, the pump mode is traced that produces a mixed Gaussian state describing only the signal pulse; this state impurity of the signal pulse can be viewed as dissipation caused by two-photon absorption or, equivalently, energy loss due to back-conversion from signal to pump.

One straightforward way to restrict the quantum dynamics to a Gaussian subspace is to take the Heisenberg equations of motion generated by (11) for the quadrature operators and perform a moment expansion up to second order [40]. The Heisenberg equations of motion for the crystal propagation of the ith signal pulse âᵢ and its corresponding pump pulse \hat{b} are:

$$\frac{d {\hat{a}}_{i}}{d τ} = ϵ \hat{b} {\hat{a}}_{i}^{†} , \frac{d \hat{b}}{d τ} = - \frac{ϵ}{2} {\hat{a}}_{i}^{2} \qquad ( 13 )$$

written for convenience âᵢ=\hat{x}ᵢ+iŷᵢ and \hat{b}=\hat{x}_{b}+iŷ_{b} so that \hat{x}ᵢ=\hat{q}ᵢ/\sqrt{2} and ŷᵢ=\hat{p}ᵢ/\sqrt{2}. Then these scaled quadrature operators evolve according to:

$$\frac{d {\hat{x}}_{i}}{d τ} = ϵ ( {\hat{x}}_{b} {\hat{x}}_{i} + {\hat{y}}_{b} {\hat{y}}_{i} ) \frac{d {\hat{x}}_{b}}{d τ} = - \frac{ϵ}{2} ( {\hat{x}}_{i}^{2} - {\hat{y}}_{i}^{2} )$$

$$\frac{d {\hat{y}}_{i}}{d τ} = ϵ ( {\hat{y}}_{b} {\hat{x}}_{i} + {\hat{x}}_{b} {\hat{y}}_{i} ) \frac{d {\hat{y}}_{b}}{d τ} = - \frac{ϵ}{2} ( {\hat{x}}_{i} {\hat{y}}_{i} + {\hat{y}}_{i} {\hat{x}}_{i} )$$

The evolution of the first-order moments can simply be obtained by taking expectation on the above equations. In order to break up the products, the relation [symbol] \hat{z}₁\hat{z}₂ [symbol] = [symbol] δ\hat{z}₁ δ\hat{z}₂ [symbol] + [symbol] \hat{z}₁ [symbol] [symbol] \hat{z}₂ [symbol] can be used to express the expectation of a product of any two operators \hat{z}₁ and \hat{z}₂ in terms of their means and covariance. However, it is also clear that in doing so, the covariances need to be tracked. To derive the covariance EOMs:

$$\frac{d}{d τ} 〈 δ {\hat{z}}_{1} δ {\hat{z}}_{2} 〉 = 〈 \frac{d {\hat{z}}_{1}}{d τ} {\hat{z}}_{2} + {\hat{z}}_{1} \frac{d {\hat{z}}_{2}}{d τ} 〉 - \frac{d}{d τ} ( 〈 {\hat{z}}_{1} 〉 〈 {\hat{z}}_{2} 〉 )$$

Crucially, in applying this equation, the Gaussian-moment assumption is made that

[symbol]

\hat{z}₁\hat{z}₂\hat{z}₃ [symbol] [symbol] [symbol] \hat{z}₁ [symbol] [symbol] δ\hat{z}₂δ\hat{z}₃ [symbol] + [symbol] \hat{z}₂ [symbol] [symbol] δ\hat{z}₁δ\hat{z}₃ [symbol] + [symbol] \hat{z}₃ [symbol] [symbol] δ\hat{z}₁δ\hat{z}₂ [symbol] + [symbol] \hat{z}₁ [symbol] [symbol] \hat{z}₂ [symbol] [symbol] \hat{z}₃ [symbol] (14)

where the third-order (non-Gaussian) central moment [symbol] δ\hat{z}₁δ\hat{z}₂δ\hat{z}₃ [symbol] =0 by assumption.

The full equations of motion derived under this procedure are provided in Appendix A. In general, since [δ\hat{x}, δŷ]=i/2 is used to obtain [symbol] δŷ δ\hat{x} [symbol] from [symbol] δ\hat{x} δŷ [symbol] , there are 10 covariances to track. However, the dynamics may be simplified further by exploiting the properties of phase-sensitive amplification. Suppose that the initial state of the system obeys (i) [symbol] ŷ₁ [symbol] = [symbol] ŷ_{b} [symbol] =0 (no quadrature-phase displacements) and (ii) [symbol] {δ\hat{x}ᵢδŷ_{i}} [symbol] = [symbol] {δ\hat{x}_{b}δŷ_{b}} [symbol] = [symbol] {δŷ_{b}δx_{i}} [symbol] =0 (all in-phase and quadrature-phase fluctuations are uncorrelated). Linear loss and out-coupling are passive operations which occur independently on the two quadratures, while the measurement and feedback injection act only on the q-quadrature, so none of the cavity operations can produce a quadrature-phase displacement nor generate correlations between the quadratures if none were there to begin with. For the crystal propagation, the full equations of motion in Appendix A are used that show that these conditions, if true at the input to the crystal, remain true throughout the crystal propagation. Thus:

$$〈 {\hat{y}}_{i} 〉 = 〈 {\hat{y}}_{b} 〉 = 0 \qquad ( 15 a )$$

$$〈 \frac{1}{2} \{ δ {\hat{x}}_{i} , δ {\hat{y}}_{i} \} 〉 = 〈 \frac{1}{2} \{ δ {\hat{x}}_{b} , δ {\hat{y}}_{b} \} 〉 = 0 \qquad ( 15 b )$$

$$〈 δ {\hat{x}}_{b} δ {\hat{y}}_{i} 〉 = 〈 δ {\hat{y}}_{b} δ {\hat{x}}_{i} 〉 = 0 \qquad ( 15 c )$$

are invariants of the crystal propagation.

The final Gaussian-state EOMs can be numerically integrated to implement the crystal propagation map of motion for the crystal propagation map in (12). The mean-field equations are given by:

$$\frac{d 〈 {\hat{x}}_{i} 〉}{d τ} = ϵ 〈 {\hat{x}}_{b} 〉 〈 {\hat{x}}_{i} 〉 + ϵ 〈 δ {\hat{x}}_{b} δ {\hat{x}}_{i} + δ {\hat{y}}_{b} δ {\hat{y}}_{i} 〉 \qquad ( 16 a )$$

$$\frac{d 〈 {\hat{x}}_{b} 〉}{d τ} = - \frac{ϵ}{2} {〈 {\hat{x}}_{i} 〉}^{2} - \frac{ϵ}{2} 〈 δ {\hat{x}}_{i}^{2} - δ {\hat{y}}_{i}^{2} 〉 \qquad ( 16 b )$$

while the covariance equations of motion are:

$$\frac{d 〈 δ {\hat{x}}_{i}^{2} 〉}{d τ} = + 2 ϵ 〈 {\hat{x}}_{b} 〉 〈 δ {\hat{x}}_{i}^{2} 〉 + 2 ϵ 〈 {\hat{x}}_{i} 〉 〈 δ {\hat{x}}_{b} δ {\hat{x}}_{i} 〉 \qquad ( 17 a )$$

$$\frac{d 〈 δ {\hat{y}}_{i}^{2} 〉}{d τ} = - 2 ϵ 〈 {\hat{x}}_{b} 〉 〈 δ {\hat{y}}_{i}^{2} 〉 + 2 ϵ 〈 {\hat{x}}_{i} 〉 〈 δ {\hat{y}}_{b} δ {\hat{y}}_{i} 〉 \qquad ( 17 b )$$

$$\frac{d 〈 δ {\hat{x}}_{b}^{2} 〉}{d τ} = - 2 ϵ 〈 {\hat{x}}_{i} 〉 〈 δ {\hat{x}}_{b} δ {\hat{x}}_{i} 〉 \qquad ( 17 c )$$

$$\frac{d 〈 δ {\hat{y}}_{b}^{2} 〉}{d τ} = - 2 ϵ 〈 {\hat{x}}_{i} 〉 〈 δ {\hat{y}}_{b} δ {\hat{y}}_{i} 〉 \qquad ( 17 d )$$

$$\frac{d 〈 δ {\hat{x}}_{b} δ {\hat{x}}_{i} 〉}{d τ} = ϵ 〈 {\hat{x}}_{i} 〉 〈 δ {x}_{b}^{2} - δ {x}_{i}^{2} 〉 + ϵ 〈 {\hat{x}}_{b} 〉 〈 δ {\hat{x}}_{b} δ {\hat{x}}_{i} 〉 \qquad ( 17 e )$$

$$\frac{d 〈 δ {\hat{y}}_{b} δ {\hat{y}}_{i} 〉}{d τ} = ϵ 〈 {\hat{x}}_{i} 〉 〈 δ {\hat{y}}_{b}^{2} - δ {y}_{i}^{2} 〉 - ϵ 〈 {\hat{x}}_{b} 〉 〈 δ {\hat{y}}_{b} δ {\hat{y}}_{i} 〉 . \qquad ( 17 f )$$

This system of ODEs consist of 8 real-valued dynamical variables and can be efficiently solved numerically and is why the method uses the quadrature operators \hat{x} and ŷ for this derivation, as the mode operators â and â† (which have complex-valued means and covariances) would have resulted in 8 complex-valued ODEs.

### Discrete-Time Dynamical Model for the MFB-CIM

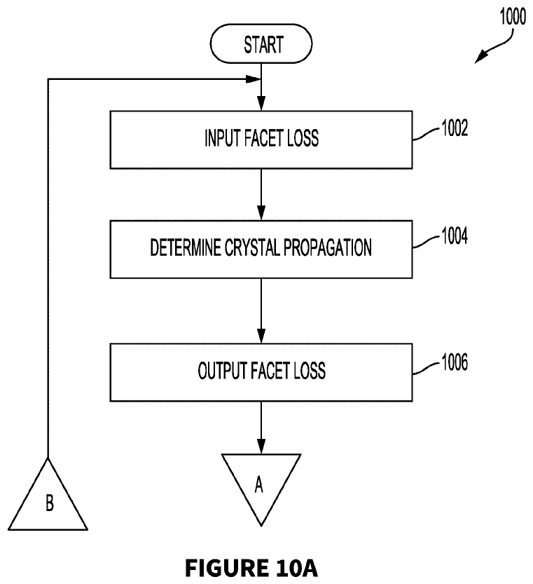

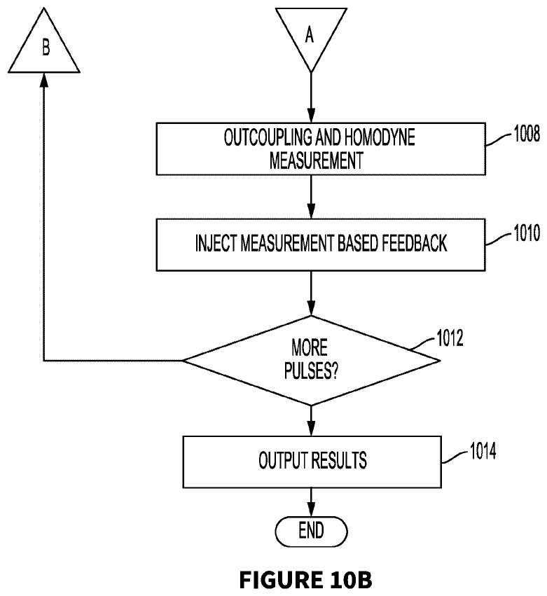

Using the above components and transformations to model the MFB-CIM, a method 1000 (shown in FIGS. 10A-10B) for an iterative procedure for generating the dynamics of the MFB-CIM are now described. If \hat{ρ}(μ⁽ⁱ⁾(n), Σ⁽ⁱ⁾(n)) denote the state of the ith pulse just before it starts its nth roundtrip through the system, which occurs at wall-clock time (nN+i)=fᵣₑₚ, where 1/fᵣₑₚ is the pulse repetition interval. Note that with this definition, the “state” ⊗ᵢ₌₁^{N}\hat{ρ}(μ⁽ⁱ⁾(n), Σ⁽ⁱ⁾(n)) technically combines signal pulse states from different times, since pulse i=1 would have entered the next roundtrip (and possibly have already interacted with some optical elements) before pulse i=N has finished the last roundtrip. Nevertheless, because the pulses experience LOCC evolution, this subtlety does not introduce a significant problem.

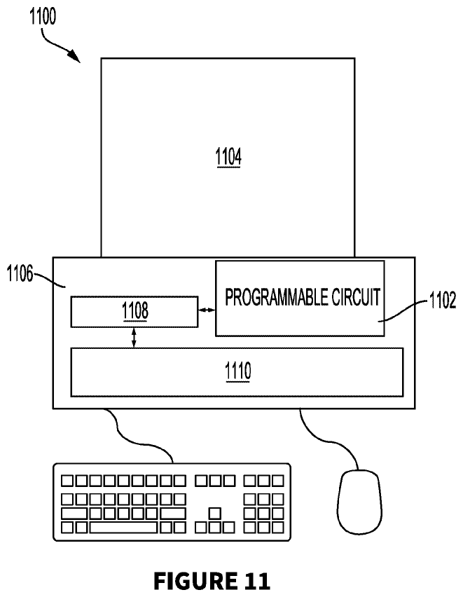

FIGS. 10A and 10B show the method 1000 to propagate the state of the ith signal pulse from \hat{ρ}(μ⁽ⁱ⁾(n), Σ⁽ⁱ⁾(n)) to \hat{ρ}(μ⁽ⁱ⁾(n+1), Σ⁽ⁱ⁾(n+1)) using the iterative method shown in FIGS. 10A and 10B. As discussed below, this method may be performed by the computer system shown in FIG. 11 or on other devices or hardware that can perform the operations of the method as discussed below. For each pulse, the method inputs the facet loss (1002). The input facet loss can be modelled as the map

\hat{ρ}(μ⁽ⁱ⁾, Σ⁽ⁱ⁾) [symbol] tr_{c}(Bᵣ_{ₗₒₛₛ}[\hat{ρ}(μ⁽ⁱ⁾, Σ^{(I)})⊗\hat{ρ}(0^{(c)}, Σ₀^{(c)})]) (18)

where [symbol] is the beamsplitter map defined by (5) and rₗₒₛₛ² is the power loss through that facet. Physically, c represents a vacuum mode which mixes with the signal pulse and is then traced out.

The method may then perform/determine crystal propagation (1004). Following (12), the crystal propagation is described by a Gaussian map producing a joint correlated signal-pump state, followed by a partial trace of the pump mode:

\hat{ρ}(μ⁽ⁱ⁾, Σ⁽ⁱ⁾) [symbol] tr_{b}(χ[\hat{ρ}(μ⁽ⁱ⁾, Σ⁽ⁱ⁾)]) (19)

where the map is obtained by solving the non-linear Gaussian EOMs (16) and (17). These EOMs depend on three parameters: the nonlinear interaction rate ετₙ₁ in the crystal Hamiltonian (11), the total propagation time τₙ₁ over which the EOMs are integrated, and the initial pump amplitude [symbol] \hat{b} [symbol] (0)= [symbol] \hat{q}b [symbol] (0)/\sqrt{2} which henceforth is denoted by = [symbol] /\sqrt{2}. Note that because propagation loss in the crystal is neglected, the first two parameters are not independent, as the physics only depends on the product ετₙ₁, which is a dimensionless non-linear interaction strength.

The method may then determine the output facet loss (1006). This process is exactly the same as for the input facet loss. Assuming the method lumps the total system losses in a

symmetric way between input and output losses around the crystal, the process in [18] can be applied again for this process.

The method then performs a outcoupling and homodyne measurement (1008). The homodyne measurement consists of two sub-processes. First, a part of the internal signal pulse is outcoupled, which can be described by the map

\hat{ρ}(μ⁽ⁱ⁾, Σ⁽ⁱ⁾) [symbol] \hat{ρ}(μ^{(i,h)}, Σ^{(i,h)})=Bᵣ_{ₒᵤₜ}[\hat{ρ}(μ⁽ⁱ⁾, Σ⁽ⁱ⁾)⊗\hat{ρ}(0^{(h)}, Σ₀^{(h)})] (20a)

where rₒᵤₜ² is the power outcoupling. This takes a probe vacuum-state external mode h and mixes it with the signal pulse at the outcoupler to produce a joint correlated state of the internal cavity mode and the external out-coupled mode. The next sub-process is to apply a homodyne measurement on the out-coupled mode, which produces a measurement result wᵢ(n) for the ith signal pulse at this roundtrip index n according to (7). This indirect measurement of the internal signal pulse projects its state according to the map

\hat{ρ}(μ^{(i,h)}, Σ^{(i,h)}) [symbol] [symbol] ₕ[\hat{ρ}(μ^{(i,h)}, Σ^{(i,h)})]=\hat{ρ}(μ_{wi}⁽ⁱ⁾, Σ_{wi}⁽ⁱ⁾), (20b)

where [symbol] is the conditional homodyne map (10), with the mean and variances computed via (9).

The method may then inject measurement feedback (1010) as shown in FIG. 10B. Thus, the method apply the coherent displacements to the signal pulses based on the feedback signal computed by the FPGA in the CIM for implementing the Ising couplings. The feedback terms may be given by:

$${v}_{i} ( n ) = {J}_{0} ( n ) {\sum }_{j = 1}^{N} {J}_{ij} {w}_{j} ( n ) \qquad ( 21 a )$$

where wᵢ(n) are the measurement results from the homodyne detection in this roundtrip, and J₀(n) is a feedback gain parameter which may generally depend on the roundtrip index n (i.e., time). The method then displaces the pulse amplitudes according to:

\hat{ρ}(μ⁽ⁱ⁾, Σ⁽ⁱ⁾) [symbol] [symbol] _{υ}_{ᵢ}[\hat{ρ}(μ⁽ⁱ⁾, Σ⁽ⁱ⁾)] (21b)

where [symbol] is the displacement operation given by (6).

In the method as shown in FIG. 10B, the method determines if there an more pulses 1012 and loops back to process 102 so that the processes in the method are applied to each pulse. The above processes, after being applied to each pulse i=1, . . . , N, completes one roundtrip through the CIM cavity. Note that the exact order in which the following operations technically depends on the details of how the fiber cavity is laid out and the relative time-of-flight between optical components. Nevertheless, generic features such as steady-state behavior should be robust against the exact choice of ordering, and if the precise transient behavior is desired, one can rearrange the procedure above to more accurately model a specific cavity layout. When the above iterative method is completed for all of the pulses, the method outputs the results (1014).

### Reduction to Continuous-Time Gaussian Models

The conventional continuous-time quantum model for the MFB-CIM in the Gaussian regime may be compared to the above method and show that the dynamics produced by the disclosed discrete-time model match those of the continuous-time model in the high-finesse limit.

### Continuous-Time Gaussian Quantum Model

The standard approach to modelling the MFB-CIM is based on input-output theory [32, 41], which describes open quantum systems coupled weakly to a set of external reservoirs. In this formalism, the dynamics are specified by a system Hamiltonian capturing the unitary evolution and a set of Lindblad operators which describe the interactions of the system with the reservoirs.

For the MFB-CIM, the system of N OPOs are represented as in the discrete-time case by optical modes with annhilation operator âᵢ. The system is coupled to three reservoirs. The first describes unmeasured linear loss and is represented by Lindblad operators \hat{L}_{loss,i}=\sqrt{2γ}âᵢ, wherein γ is the field decay rate due to this loss. The second describes measurement at the output coupler and is represented by Lindblad operators \hat{L}_{out,i}=\sqrt{2κ}âᵢ where κ is the field out-coupling rate. Finally, gain saturation is modelled as a two-photon loss corresponding to back-conversion of the signal eld into pump and is represented by Lindblad operators \hat{L}_{tpl,i}=\sqrt{g}âᵢ² where g is the two-photon loss rate.

The Hamiltonian consists of two coherent effects. The first is generated by the external pumping of the non-linear crystal, which gives a contribution of the form

$$( \frac{ip}{2} ) {\hat{a}}_{i}^{†2} + H . c .$$

where p is the field pump rate. The second is generated by external feedback injection, which is a function of the homodyne measurement record obtained from monitoring the output channels \hat{L}_{out,i}. The measurement record may be denoted by

mᵢ(t)= [symbol] \hat{L}_{out,i}+\hat{L}†_{out,i} [symbol] +ξᵢ(t) (22)

where ξᵢ(t) is a real-valued standard white noise process with δ-function correlations ξᵢ(t)ξⱼ(t′)=δᵢⱼδ(t−t′). Taken together, the system Hamiltonian is given by

$$\hat{H} ( t ) = \frac{i}{2} {\sum }_{i} ( p {\hat{a}}_{i}^{†2} + λ \frac{{f}_{i} ( t )}{\sqrt{2 κ}} {\hat{a}}_{i}^{†} ) + H . c . \qquad ( 23 )$$

where fᵢ(t)=ΣⱼJᵢⱼmⱼ(t) is the feedback signal.

Because the measurement records mi(t) constitute continuous weak measurements of the system state, the dynamics of the system are stochastic and conditional on mᵢ(t). In standard input-output theory, such dynamics are generated by a stochastic master equation (SME) [42]

$$\frac{d \hat{ρ}}{dt} = - i [ \hat{H} ( t ) , \hat{ρ} ] + {\sum }_{i} {ξ}_{i} ( t ) ℋ [ {\hat{L}}_{out , i} ] \hat{ρ} + {\sum }_{i} ( 𝒟 [ {\hat{L}}_{out , i} ] + 𝒟 [ {\hat{L}}_{loss , i} ] + 𝒟 [ {\hat{L}}_{tpl , i} ] ) \hat{ρ} , \qquad ( 24 )$$

$$where 𝒟 [ \hat{A} ] \hat{ρ} = \hat{A} \hat{ρ} {\hat{A}}^{†} - \frac{1}{2} \{ {\hat{A}}^{†} \hat{A} , \hat{ρ} \}$$

is the Liouvillian superoperator and [symbol] [Â]\hat{ρ}={Â, \hat{ρ}}− [symbol] Â+Â† [symbol] \hat{ρ}.

From the SME, the conditional evolution of any desired observable can be obtained. To establish a correspondence with the discrete-time model, we are particularly interested in the mean and variance of the in-phase quadrature \hat{q}ᵢ. In general, the expectation value of an observable \hat{X} has the equation of motion

$$\frac{d 〈 \hat{X} 〉}{dt} = - i 〈 [ \hat{X} , \hat{H} ( t ) ] 〉 + {\sum }_{i} {ξ}_{i} ( t ) 〈 ℋ [ {\hat{L}}_{out , i}^{†} ] \hat{X} 〉 + {\sum }_{i} 〈 ( 𝒟 [ {\hat{L}}_{out , i}^{†} ] + 𝒟 [ {\hat{L}}_{loss , i}^{†} ] + 𝒟 [ {\hat{L}}_{tpl , i}^{†} ] ) \hat{X} 〉 . \qquad ( 25 )$$

We consider \hat{X} to be \hat{q}ᵢ and [symbol] ᵢ² obtain the dynamics of the mean and variance, respectively. As in the discrete-time case, in order to arrive at a closed set of diffrential equations for the evolution, we require the assumption that the state \hat{p} is a Gaussian state at all times. As in the discrete-time model, this assumption holds when the single-photon nonlinearity is small relative to the linear loss/measurement rates, i.e., g<<κ+γ. As shown in Appendix B, expectation values of quadrature operators can be evaluated under this assumption to arrive at:

$$\frac{d 〈 {\hat{q}}_{i} 〉}{dt} = ( p - κ - γ ) 〈 {\hat{q}}_{i} 〉 - \frac{g}{2} {〈 {\hat{q}}_{i} 〉}^{3} + λ {\sum }_{j} {J}_{ij} 〈 {\hat{q}}_{j} 〉 + 2 \sqrt{κ} ( 〈 δ {\hat{q}}_{i}^{2} 〉 - \frac{1}{2} ) {ξ}_{i} + \frac{λ}{2 \sqrt{κ}} {\sum }_{j} {J}_{ij} {ξ}_{j} - \frac{g}{2} 〈 {\hat{q}}_{i} 〉 ( 3 〈 δ {\hat{q}}_{i}^{2} 〉 + 〈 δ {\hat{p}}_{i}^{2} 〉 - 2 ) \qquad ( 26 a )$$

$$\frac{d 〈 δ {\hat{q}}_{i}^{2} 〉}{dt} = 2 ( p - κ - γ ) 〈 δ {\hat{q}}_{i}^{2} 〉 - 4 {κ ( 〈 δ {\hat{q}}_{i}^{2} 〉 - \frac{1}{2} )}^{2} + κ + γ - 3 g {〈 {\hat{q}}_{i} 〉}^{2} 〈 δ {\hat{q}}_{i}^{2} 〉 + g {〈 {\hat{q}}_{i} 〉}^{2} + g ( - 3 {〈 δ {\hat{q}}_{i}^{2} 〉}^{2} - 〈 δ {\hat{q}}_{i}^{2} 〉 〈 δ {\hat{p}}_{i}^{2} 〉 + 〈 δ {\hat{p}}_{i}^{2} 〉 - 1 ) . \qquad ( 26 b )$$

For the Gaussian model to be valid the single-photon nonlinearity has to be relatively weak (i.e. g<<κ+γ). Thus, terms following g should only be kept if the term accompanying the g has the capacity to be large. This is for instance satisified in the saturation term −g [symbol] \hat{q}ᵢ [symbol] ³ where a large displacement [symbol] \hat{q}ᵢ [symbol] ² will make it comparable to the other terms (such as (p−κ−γ) [symbol] \hat{q}ᵢ [symbol] in the differential equation. Under this reasoning, the final terms of both equations in (26) can in fact be neglected since the terms accompanying them are small assuming that the amount of squeezing in the CIM is modest due to the presence of loss. Removing those terms, the simplified continuous-time Gaussian model is:

$$\frac{d 〈 {\hat{q}}_{i} 〉}{dt} = ( p - κ - γ ) 〈 {\hat{q}}_{i} 〉 - \frac{g}{2} {〈 {\hat{q}}_{i} 〉}^{3} + λ {\sum }_{j} {J}_{ij} 〈 {\hat{q}}_{j} 〉 + 2 \sqrt{κ} ( 〈 δ {\hat{q}}_{i}^{2} 〉 - \frac{1}{2} ) {ξ}_{i} + \frac{λ}{2 \sqrt{κ}} {\sum }_{j} {J}_{ij} {ξ}_{j} \qquad ( 27 a )$$

$$\frac{d 〈 δ {\hat{q}}_{i}^{2} 〉}{dt} = 2 p 〈 δ {\hat{q}}_{i}^{2} 〉 - 2 ( γ + κ ) ( 〈 δ {\hat{q}}_{i}^{2} 〉 - \frac{1}{2} ) - 4 {κ ( 〈 δ {\hat{q}}_{i}^{2} 〉 - \frac{1}{2} )}^{2} - 2 g {〈 {\hat{q}}_{i} 〉}^{2} ( \frac{3}{2} 〈 δ {\hat{q}}_{i}^{2} 〉 - \frac{1}{2} ) . \qquad ( 27 b )$$

The continuous-time dynamics are fully specified given the rates κ, γ, g, p, and λ.

### High-Finesse Limit Of Discrete-Time Dynamics

The continuous-time dynamics of the form (27) can be obtained from the discrete-time model in the high-finesse limit. In the high-finesse limit, each discrete operation only implements an infinitesimal change \hat{ρ} [symbol] \hat{ρ}+d\hat{ρ} to the state \hat{ρ} and, as in the Trotterization of quantum dynamics [43, 44], the exact order in which the operations are composed within one roundtrip becomes unimportant to analyze the operations in the method 1000 shown in FIGS. 10A and 10B independently within one roundtrip.

A parameter δ is introduced such that δ→0 formally defines the high-finesse limit. The MFB-CIM roundtrip time (as measured by a wall clock) is assumed to be Δt=N/fᵣₑₚ˜δ. The model parameters which appear in the method 1000 scale as follows:

rₗₒₛₛ²˜rₒᵤₜ²˜β²˜(ϵτₙ₁)²˜J₀²˜δ (28)

As necessitated by working in the Gaussian regime, the method assumes that, for any fixed δ, ετₙ₁<<rₗₒₛₛ²+rₒᵤₜ².

Each of the operations in the method 1000 discussed above can be expanded to their leading order correction in δ. As explained in the previous subsection for the discrete-time model and as shown in (27) for the continuous-time model, the q- and p-quadratures of the dynamics are decoupled, so we only consider the dynamics of \hat{q}ᵢ below.

First, the linear loss at the facets may be given by (18). Using (5), this produces the mapping

$$〈 {\hat{q}}_{i} 〉 ↦ \sqrt{1 - {r}_{loss}^{2}} 〈 {\hat{q}}_{i} 〉 = ( 1 - \frac{1}{2} {r}_{loss}^{2} ) 〈 {\hat{q}}_{i} 〉 + 𝒪 ( {δ}^{2} ) \qquad ( 29 a )$$

$$〈 δ {\hat{q}}_{i}^{2} 〉 ↦ ( 1 - {r}_{loss}^{2} ) 〈 δ {\hat{q}}_{i}^{2} 〉 + \frac{1}{2} {r}_{loss}^{2} . \qquad ( 29 b )$$

Since there are two of these facets in a given round-trip, cascading the discrete map twice gives

[symbol]

\hat{q}ᵢ [symbol] (1−rₗₒₛₛ²) [symbol] \hat{q}ᵢ [symbol] + [symbol] (δ²) (30a)

[symbol]

δ\hat{q}ᵢ² [symbol] (1−2rₗₒₛₛ²) [symbol] δ\hat{q}ᵢ² [symbol] +rₗₒₛₛ²+ [symbol] (δ²). (30b)

Second, for crystal propagation, since map (12) requires integrating the nonlinear EOMs (16) and (17), the method uses Picard iteration to solve the EOMs, while only keeping term of [symbol] (δ); the result is be an analytic map for [symbol] \hat{q}ᵢ [symbol] and [symbol] δ\hat{q}² [symbol] correct up to [symbol] (δ). The initial conditions used are:

$$〈 {\hat{x}}_{i} 〉 ( 0 ) = \frac{1}{\sqrt{2}} 〈 {\hat{q}}_{i} 〉 〈 {\hat{x}}_{b} 〉 ( 0 ) = \frac{1}{\sqrt{2}} β \qquad ( 31 a )$$

$$〈 δ {\hat{x}}_{i}^{2} 〉 ( 0 ) = \frac{1}{2} 〈 δ {q}_{i}^{2} 〉 〈 δ {\hat{y}}_{i}^{2} 〉 ( 0 ) = \frac{1}{2} 〈 δ {p}_{i}^{2} 〉 \qquad ( 31 b )$$

$$〈 δ {\hat{x}}_{b}^{2} 〉 ( 0 ) = \frac{1}{4} 〈 δ {\hat{y}}_{b}^{2} 〉 ( 0 ) = \frac{1}{4} \qquad ( 31 c )$$

$$〈 δ {\hat{x}}_{i} 〉 ( 0 ) = \frac{1}{2} 〈 δ {q}_{i}^{2} 〉 〈 δ {\hat{y}}_{i}^{2} 〉 ( 0 ) = \frac{1}{2} 〈 δ {p}_{i}^{2} 〉 \qquad ( 31 d )$$

$$〈 δ {\hat{x}}_{b} δ {\hat{x}}_{i} 〉 ( 0 ) = 0 〈 δ {\hat{y}}_{b} δ {\hat{y}}_{i} 〉 ( 0 ) = 0. \qquad ( 31 e )$$

After applying Picard iteration, the crystal propagation in the high-finesse limit produces:

$$〈 {\hat{q}}_{i} 〉 ↦ 〈 {\hat{q}}_{i} 〉 + \frac{1}{\sqrt{2}} β ϵ {τ}_{nl} 〈 {q}_{i} 〉 - \frac{1}{8} {( ϵ {τ}_{nl} )}^{2} {〈 {\hat{q}}_{i} 〉}^{3} - \frac{1}{8} {( ϵ {τ}_{nl} )}^{2} 〈 {\hat{q}}_{i} 〉 ( 3 〈 δ {q}_{i}^{2} 〉 + 〈 δ {\hat{p}}_{i}^{2} 〉 - 2 ) + 𝒪 ( {δ}^{2} ) \qquad ( 32 a )$$

$$〈 δ {\hat{q}}_{i}^{2} 〉 ↦ 〈 δ {\hat{q}}_{i}^{2} 〉 + \sqrt{2} {βϵτ}_{nl} 〈 δ {\hat{q}}_{i}^{2} 〉 - \frac{3}{4} {( ϵ {τ}_{nl} )}^{2} {〈 {\hat{q}}_{i} 〉}^{2} 〈 δ {\hat{q}}_{i}^{2} 〉 + \frac{1}{4} {( ϵ {τ}_{nl} )}^{2} {〈 {\hat{q}}_{i} 〉}^{2} - \frac{1}{4} {( ϵ {τ}_{nl} )}^{2} 〈 δ {q}_{i}^{2} 〉 ( 〈 δ {\hat{q}}_{i}^{2} 〉 - 〈 δ {p}_{i}^{2} 〉 ) + 𝒪 ( {δ}^{2} ) . \qquad ( 32 b )$$

We see that the last terms in both of the above equations are associated with lower powers of the mean [symbol] \hat{q}ᵢ [symbol] and can be neglected via the following argument. Since, the outcoupling and linear loss have the effect of keeping the variances close to unity, these terms are of order (ετₙ₁)² which is much smaller than the terms associated with linear loss that have order rₗₒₛₛ²+rₒᵤₜ². This is analogous to the elimination of the final terms in (26), where the continuous-time counterpart of the necessary conditions for the Gaussian approximation (i.e. g<<κ+γ) to hold is enforced to eliminate them.

Third, for the measurement process and the outcoupling step, the signal state changes according to:

$$〈 {\hat{q}}_{i} 〉 ↦ ( 1 - \frac{1}{2} {r}_{out}^{2} ) 〈 {\hat{q}}_{i} 〉 + 𝒪 ( {δ}^{2} ) \qquad ( 33 a )$$

$$〈 δ {\hat{q}}_{i}^{2} 〉 ↦ ( 1 - {r}_{out}^{2} ) 〈 δ {\hat{q}}_{i}^{2} 〉 + \frac{1}{2} {r}_{out}^{2} , \qquad ( 33 b )$$

and also produces a weak correlation between \hat{q}ᵢ and an external mode (labelled here by a subscript h), with mean, variance, and covariance

$$〈 {\hat{q}}_{h} 〉 = {r}_{out} 〈 {\hat{q}}_{i} 〉 \qquad ( 34 a )$$

$$〈 δ {\hat{q}}_{h}^{2} 〉 = \frac{1}{2} + {r}_{out}^{2} ( 〈 δ {\hat{q}}_{i}^{2} 〉 - \frac{1}{2} ) \qquad ( 34 b )$$

$$〈 δ {\hat{q}}_{i} δ {\hat{q}}_{h} 〉 = {r}_{out} \sqrt{1 - {r}_{out}^{2}} ( 〈 δ {\hat{q}}_{i}^{2} 〉 - \frac{1}{2} ) . \qquad ( 34 c )$$

After this, the outcoupled field is measured by homodyne, which by (7) produces a measurement result

wᵢ= [symbol] ( [symbol] \hat{q}ₕ [symbol] , [symbol] δ\hat{q}ₕ² [symbol] ). (35)

At the same time, backaction on the internal state by (9) produces the map

$$〈 {\hat{q}}_{i} 〉 ↦ 〈 {\hat{q}}_{i} 〉 + ( \frac{{w}_{i} - 〈 {\hat{q}}_{h} 〉}{〈 δ {\hat{q}}_{h}^{2} 〉} ) 〈 δ {\hat{q}}_{i} δ {\hat{q}}_{h} 〉 = 〈 {\hat{q}}_{i} 〉 + \sqrt{2} {r}_{out} ( 〈 δ {\hat{q}}_{i}^{2} 〉 - \frac{1}{2} ) {z}_{i} 𝒪 ( {δ}^{3 / 2} ) \qquad ( 36 a )$$

$$〈 δ {\hat{q}}_{i}^{2} 〉 ↦ 〈 δ {\hat{q}}_{i}^{2} 〉 - \frac{{〈 δ {\hat{q}}_{i} δ {\hat{q}}_{h} 〉}^{2}}{〈 δ {\hat{q}}_{h}^{2} 〉} = 〈 δ {\hat{q}}_{i}^{2} 〉 - 2 {{r}_{out}^{2} ( 〈 δ {\hat{q}}_{i}^{2} 〉 - \frac{1}{2} )}^{2} + 𝒪 ( {δ}^{2} ) \qquad ( 36 b )$$

where zᵢ˜ [symbol] (0, 1) is a standard normal random variable.

Finally, the injection feedback via (21) and, given the measurement results (35), the displacement applied is given by υᵢ=J₀ΣⱼJᵢⱼwⱼ which produces:

$$〈 {\hat{q}}_{i} 〉 ↦ 〈 {\hat{q}}_{i} 〉 + {J}_{0} {\sum }_{j} {J}_{ij} {w}_{j} = 〈 {\hat{q}}_{i} 〉 + {J}_{0} {\sum }_{j} {J}_{ij} ( \frac{1}{\sqrt{2}} {z}_{i} + {r}_{out} 〈 {\hat{q}}_{i} 〉 ) + 𝒪 ( {δ}^{3 / 2} ) , \qquad ( 37 )$$

and the variance [symbol] δ\hat{q}₁² [symbol] is unchanged by the feedback.

All the maps within a single roundtrip by combining the effects (again, without regards to order) from (29), (31), (32), (35), and (36) to first order in δ. Denoting the updated mean and variance with a prime, the discrete-time finite-difference maps describing one roundtrip limit to the continuous-time differential equations

$${lim}_{Δ t \to 0} \frac{{〈 {\hat{q}}_{i} 〉}^{′} - 〈 {\hat{q}}_{i} 〉}{Δ t} = \frac{d 〈 {\hat{q}}_{i} 〉}{dt} \qquad ( 38 a )$$

$${lim}_{Δ t \to 0} \frac{{〈 δ {\hat{q}}_{i}^{2} 〉}^{′} - 〈 δ {\hat{q}}_{i}^{2} 〉}{Δ t} = \frac{d 〈 δ {\hat{q}}_{i}^{2} 〉}{dt} , \qquad ( 38 b )$$

precisely as given by the continuous-time model in (27), provided that

$$γ = \frac{{r}_{loss}^{2}}{Δ t} κ = \frac{{r}_{out}^{2}}{2 Δ t} \qquad ( 39 a )$$

$$p = \frac{{βϵτ}_{nl}}{\sqrt{2} Δ t} g = \frac{{( ϵ {τ}_{nl} )}^{2}}{4 Δ t} \qquad ( 39 b )$$

$$λ = \frac{{J}_{0} {r}_{out}}{Δ t} {ξ}_{i} = \frac{{z}_{i}}{\sqrt{Δ t}} . \qquad ( 39 c )$$

These are the explicit relationships between the continuous-time rates and the parameters that appear in the discrete-time model in the high-finesse regime.

Finally, as an alternative to the above approach where the correspondence is derived via Picard iteration on the (c-number) Gaussian-state EOMs, it is also possible to arrive at the same conclusions via a quantum input-output analysis of the crystal Hamiltonian (11). For example, on one propagation, the crystal implements a unitary operation

$${\hat{U}}_{nl} = {e}^{- i {\hat{H}}_{nl} {τ}_{nl}} = exp ( \frac{ϵ {τ}_{nl}}{2} {\sum }_{i} {\hat{b}}_{i} {\hat{a}}_{i}^{†2} - H . c . ) . \qquad ( 40 )$$

The pump operator can be decomposed as the sum of a coherent-excitation part and a quantum noise part, via \hat{b}ᵢ=βᵢ/\sqrt{2}+δ\hat{b}ᵢ allowing the method to treat the parametric amplification and the nonlinear parametric quantum fluctuations separately. With this substitution:

$${\hat{U}}_{nl} = exp ( \frac{β {ϵτ}_{nl}}{2 \sqrt{2}} {\sum }_{i} {\hat{a}}_{i}^{†2} + \frac{{ϵτ}_{nl}}{2} {\sum }_{i} δ {\hat{b}}_{i} {\hat{a}}_{i}^{†2} - H . c . ) \qquad ( 41 )$$

In the high-finesse limit where β²˜(ε96 ₙ₁)²˜Δt˜δ, this unitary evolution can be made compatible with a discrete-map picture of the dynamics if the method Trotterize [44] the above unitary over one roundtrip time by writing

\hat{U}ₙ₁=exp(−iĤ_{sqz}Δt)exp(−iĤₜₚₗΔt)+ [symbol] (δ^{3/2}), (42a)

where the first exponential effects a rotation [symbol] (δ) and is generated by a squeezing Hamiltonian

$${\hat{H}}_{sqz} = \frac{i}{2} \frac{{βϵτ}_{n l}}{{\underbrace{\sqrt{2} Δ t}}_{p}} {\sum }_{i} {\hat{a}}_{i}^{† 2} + H . c . , \qquad ( 42 b )$$

while the second exponential effects a rotation [symbol] (δ^{1/2}) and is generated by an interaction Hamiltonian that can be written as

$${\hat{H}}_{tpl} = i \frac{{ϵτ}_{n l}}{{\underbrace{2 \sqrt{Δ t}}}_{\sqrt{g}}} {\sum }_{i} {\hat{b}}_{i}^{( in , t )} {\hat{a}}_{i}^{†2} + H . c . , \qquad ( 42 c )$$

where in the limit Δt˜δ→0, the quantum white-noise operators \hat{b}ᵢ^{(in,t)}=δ\hat{b}ᵢ/\sqrt{Δt} have Dirac-delta commutation relations [\hat{b}ᵢ^{(in,t)}, \hat{b}_{i′}^{(in,t′)†}]=δ_{i,i}, δ(t−t′).

In a continuous-time theory over many roundtrips, (42b) is precisely the gain/squeezing part of the continuous-time system Hamiltonian (23), while (42c) is an input-output interaction Hamiltonian that formally defines the continuous-time Lindblad operator \hat{L}_{tpl,i} in the continuous-time model. This process of Trotterizing discrete-time operations can also be applied to all the linear operations (loss, out-coupling, measurement, and feedback) as well.

### Numerical Results

The numerical simulations of the discrete-time Gaussian model are provided along with some representative trajectories of the model dynamics and define a suitable metric for sampling performance.

### Model Parameters

For the numerical results, it is useful to define a new set of parameters which scale the model more conveniently by keeping certain qualitative features constant. The dynamics of an uncoupled classical DOPO are critically determined by four parameters: (1) the cavity-photon 1/e²-decay time in the absence of pumping; (2) the pump parameter r=β/βₜₕ giving the ratio between the pump field β over its threshold value βₜₕ; and (3) the saturation photon number nₛₐₜ. Each of these quantities may be expressed in terms of the model parameters given above. For convenience, the method may use:

Rₒᵤₜ=rₒᵤₜ² (43a)

Rₗₒₛₛ=1−(1−rₗₒₛₛ²)², (43b)

where the latter quantity represents the total fraction of power lost through both facets.

First, in the absence of pumping or nonlinearity, the number of roundtrips T_{decay} required for the photon number to attenuate by a factor of 1/e² due to linear loss and outcoupling is simply given by

1/T_{decay}=−log[(1−Rₒᵤₜ)^{1/2}(1−Rₗₒₛₛ)^{1/2}]. (44)

In addition, because T_{decay} captures the effect of rₗₒₛₛ and rₒᵤₜ together, it is also convenient to define an “escape efficiency” parameter

$${η}_{esc} = \frac{{R}_{out}}{1 - ( 1 - {R}_{out} ) ( 1 - {R}_{loss} )} \qquad ( 45 )$$

which captures the relative amount of (power) attenuation due to outcoupling.

Classically, the threshold pump field is defined to be the value of β (i.e., the input pump pulse amplitude) such that the exponential gain experienced by a small-signal input into the crystal (i.e., a signal pulse with vanishing amplitude) exactly balances the attenuation due to linear loss and outcoupling. The pump parameter is then simply the pump field divided by this threshold value βₜₕ. Thus, the definitions are:

$$r = \frac{β}{{β}_{th}} , where {β}_{th} = \frac{\sqrt{2}}{{ϵτ}_{nl}} \frac{1}{{T}_{decay}} . \qquad ( 46 )$$

Classically, the saturation photon number is the square of the mean-eld signal amplitude at steady-state at r=2, with contributions from linear loss/outcoupling, parametric gain, and nonlinear gain saturation. Because this feature involves the nonlinear terms of the crystal EOMs at finite signal amplitude, the exact value of the saturation photon number can depend on cavity layout for low-finesse cavities. In the high-finesse limit, however, it is given by

$${n}_{sat} = \frac{8}{{( ϵ {τ}_{nl} )}^{2}} \frac{1}{{T}_{decay}} . \qquad ( 47 )$$

When the roundtrip attenuation is moderately low (˜0.4 in power), ετₙ₁<<1, and use the above equation to define the parameter nₛₐₜ, so that for a fixed T_{decay}, specifying nₛₐₜ determines ετₙ₁, which then fixes βₜₕ. When the roundtrip attenuation is large, however, it may be the case that a given nₛₐₜ results in ετₙ₁ Not <<1, which is inconsistent with a Gaussian-state approximation for the crystal propagation. To handle these cases:

$${( {ϵτ}_{nl} )}^{2} = min ( \frac{8}{{n}_{sat} {T}_{decay}} , {10}^{- 2} ) , \qquad ( 48 )$$

where 10⁻² is taken as an appropriate maximal value to respect the Gaussian-state approximation in the absence of crystal propagation losses. In this latter case, (46) and (47) are replaced with βₜₕ=(10 \sqrt{2})/T_{decay} and nₛₐₜ=800/T_{decay}.

Finally, with regards to the injection-feedback coupling for r<1, the feedback gain J₀ needed for the system to be above threshold due to feedback gain scales with \sqrt{T_{decay}} but also with the Ising matrix entries Jᵢⱼ. To this end, a feedback gain parameter may be defined as

α=J₀\sqrt{T_{decay}}(Σ_{i≠j}|Jᵢⱼ|)^{1/2}. (49)

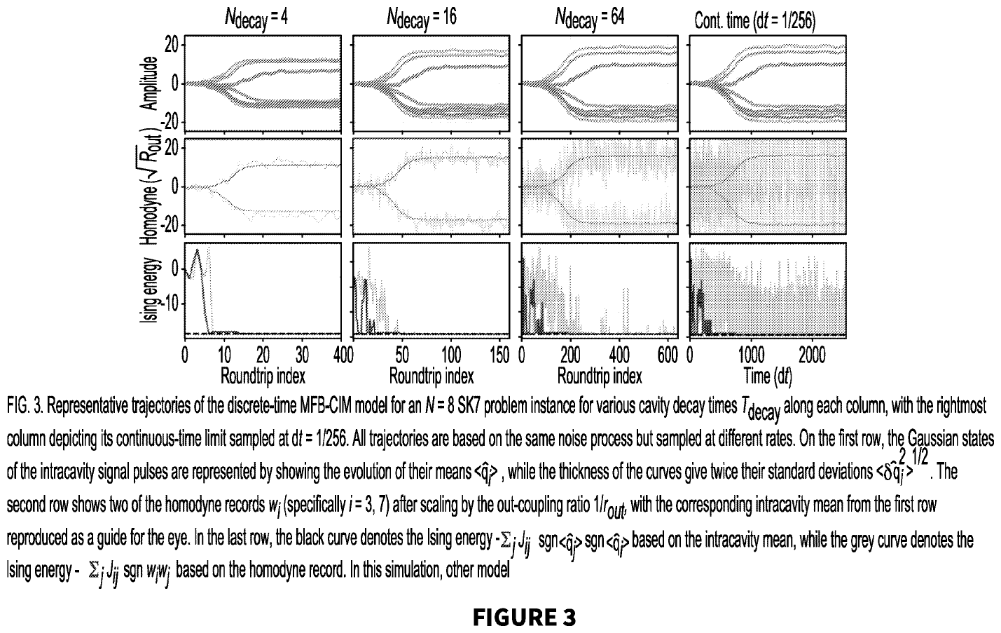

FIG. 3 shows some representative dynamics of the MFB-CIM running on a small N=8 problem instance. Note in particular how these trajectories change as a function of T_{decay} while all other model parameters are held constant. By running the simulation for 10 T_{decay} in all cases, there is a qualitative difference seen in going from a low-finesse system (T_{decay}=4), to an intermediate-finesse one (T_{decay}=16), to a high-finesse one (T_{decay}=64), but the internal Gaussian-state dynamics eventually converge to a single continuous-time trajectory in the high-finesse limit, as depicted on the right-most column. As expected, the homodyne record wi (and hence the measured Ising energy—ΣⱼJᵢⱼwᵢwⱼ) becomes increasingly noisy due to the fact that the outcoupling ratio rₒᵤₜ˜1/\sqrt{T_{decay}}. In addition, if the wall-clock roundtrip time is fixed (corresponding to the time between successive points in the discrete-time model, or to dt in the continuous-time model), it follows that the low-finesse system takes a shorter time to reach steady-state (i.e., ˜40 roundtrips for T_{decay}=4 vs. 640 roundtrips for T_{decay}=64), all else being equal. This scaling plays an important role in the overall time-to-sample as we analyze later.

### Ising Sampling in Gaussian MFB-Cims

As seen in FIG. 3, the dynamics of the MFB-CIM drive the system towards an above-threshold steady state where the sign configuration of the DOPOs encode a low-energy spin configuration of the Ising problem. At the same time, the exact spin configuration found by the MFB-CIM in these dynamics is stochastic, being driven via measurement backaction and feedback through homodyne detection. In certain regimes of operation, the MFB-CIM can be used to stochastically sample different spin configurations, simply by running the same system under different realizations of the measurement noise. Each “run” of the MFB-CIM would consist of a trajectory like the one shown in FIG. 3, which takes [symbol] (T_{decay}) roundtrips to collect and would consist of one or more samples of low-energy Ising spin configurations, after an initial transient period; repeated runs then generate new samples stochastically. The efficiency of the sampling is thus characterized by the likelihood of a given trajectory to yield at least one sample of interest, while the fairness of the sampling is determined by how uniformly spin confiurations of interest are distributed over an ensemble of trajectories.

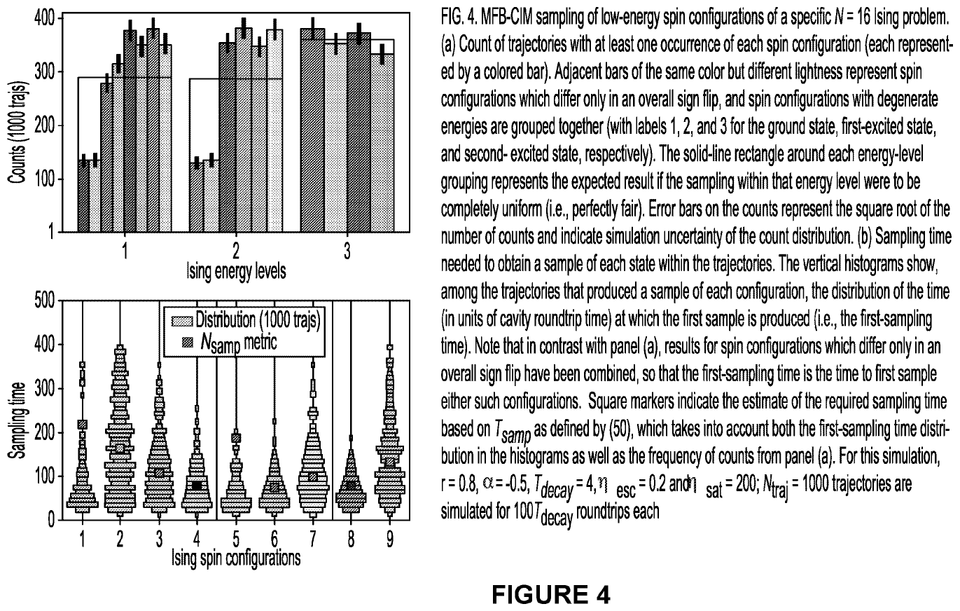

The bar graph in FIG. 4(a) illustrates this procedure for a specific N=16 problem instance, by recording, for each low-energy Ising spin configuration, the number of trajectories where that configuration appeared at least once. Over the course of 1000 trajectories, the method and system easily obtain multiple samples of every spin configuration of interest, indicating relatively fair sampling at least for this instance. Nevertheless, there are some systematic biases in the sampling; i.e., the spin configurations in a given energy level are not necessarily uniformly sampled. These biases are problem-dependent in general but also depend on the model parameters chosen for the sampling process.

To fully quantify the efficiency and fairness of the sampling, however, it is not sufficient to simply count trajectories in which each spin configuration appears, since certain configurations may systematically appear later than other configurations within any given trajectory. These differences in sampling time within a trajectory are illustrated in FIG. 4(b), where, for each spin configuration considered in FIG. 4(a) (up to an overall spin flip), a (vertical) histogram is shown of the first time in which that configuration appeared in each trajectory, if it appeared at all. In all cases, there is an initial transient period (˜T_{decay} roundtrips) in which low-energy samples cannot be generated, and most of the distributions are peaked within a few decay times of the transient. However, the exact distribution of this first-sampling time differs from one spin configuration to the next, with some configurations featuring sharper peaks and others having longer tails. As a result, a spin configuration which appears less often on a per-trajectory basis may nevertheless be efficient to sample if it appears early in the trajectories in which it appears at all.

A “required sampling time” metric may be defined in order to take into account these effects, including the biases in overall counts, the transient-time costs, and the variation in the first-sampling-time distributions. For example, if an ensemble of homodyne records wᵢ^{(l)}(k) has been collected, where 1≤1≤Nₜᵣₐⱼ denotes different trajectories, 1≤i≤N denotes the DOPO index, and k≥1 indexes the number of roundtrips elapsed. Suppose further, the method is sampling a particular Ising spin configuration σ=(σ₁, . . . , σ_{N}). Then the first-sampling time of σ in trajectory 1 may be defined as

$${T}_{samp}^{( ℓ )} ( σ ) = {min}_{k \geq 0} \{ \text{k:} ∀ i \leq N , sgn {w}_{i}^{( ℓ )} ( k ) = {σ}_{i} \} , \qquad ( 50 a )$$

where we take min Ø=∞ by convention for trajectories that produce no samples of σ. Then given a sufficiently large number of trajectories Nₜᵣₐⱼ, each simulated for a sufficiently long time, an estimate for the required number of roundtrips to sample is Tₛₐₘₚ(σ), where

$$\frac{1}{{T}_{samp} ( σ )} = \frac{1}{{N}_{traj}} {\sum }_{ℓ = 1}^{{N}_{traj}} \frac{1}{{T}_{samp}^{( ℓ )} ( σ )} . \qquad ( 50 b )$$

Under this metric, a spin configuration that is realized less often (so 1/Tₛₐₘₚ^{(l)}=0 for more values of 1 will have larger Tₛₐₘₚ, as will a spin configuration that takes longer to appear (so Tₛₐₘₚ^{(l)} is finite but large). As a result, Tₛₐₘₚ(σ) captures, in an a posteriori sense, the observed efficiency for sampling the configuration σ.

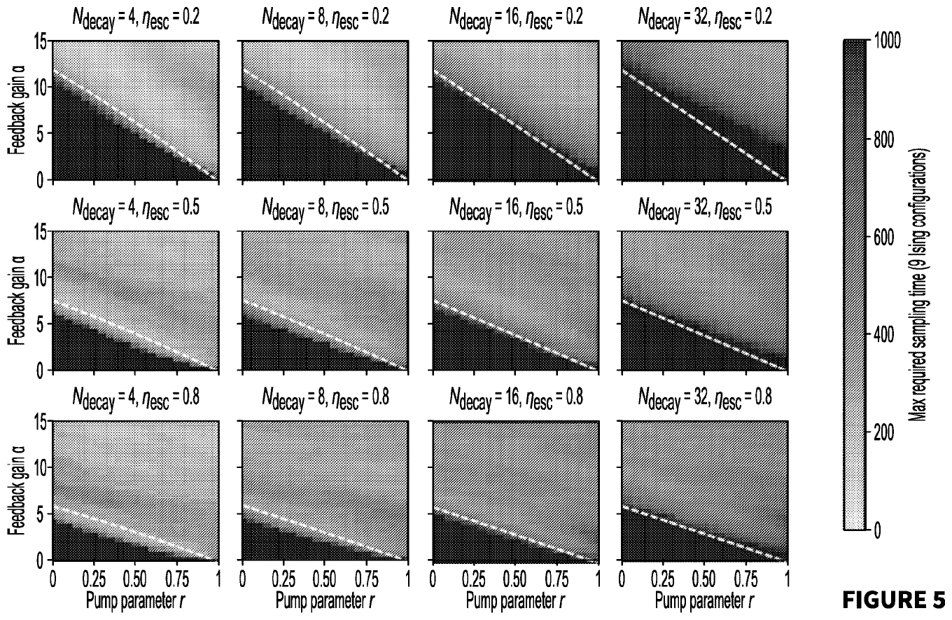

This defined empirical measure of required sampling time is affected by the model parameters, especially the feedback gain and the pump strength. FIG. 5 shows how the largest required sampling time Tₛₐₘₚ varies across different model parameters for the problem instance and spin configurations considered in FIG. 4. Efficient sampling in the MFB-CIM is relatively robust across a wide range of system parameters. The most critical parameters are the feedback gain α and the pump parameter r, which show a sharp threshold in sampling performance near the estimated linear threshold of the MFB-CIM. The required sampling time is lower for systems with a faster cavity decay time (i.e.,T_{decay}=4), which is a reflection of the fact that a low-fnesse cavity spends fewer roundtrips in the transient period and can yield low-energy samples more quickly. There also appears to be a slight advantage to using a system with lower escape efficiency (higher unmeasured losses), which may be due to a reduction in effect of measurement backaction in such regimes.

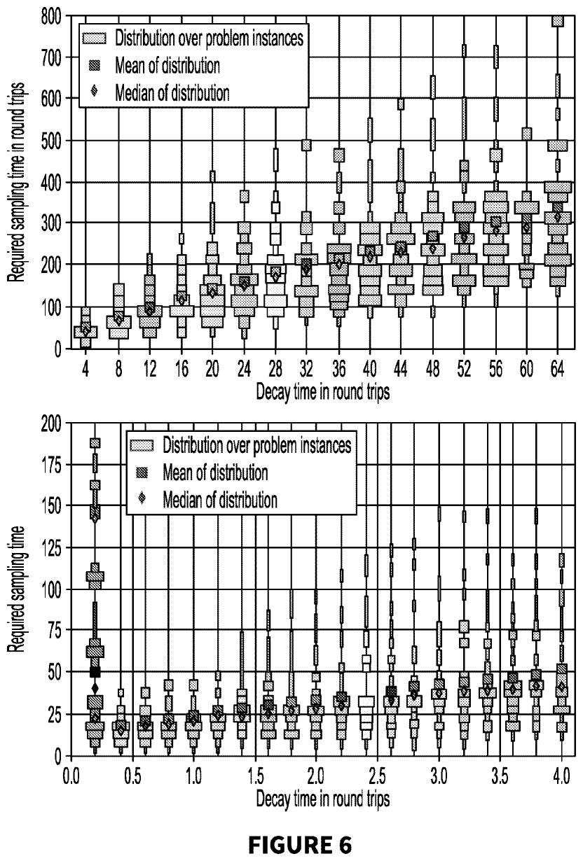

One particularly intriguing aspect of the sampling behavior in the MFB-CIM is that the required sampling time scales with the finesse of the system as measured by T_{decay}. To check whether this scaling is robust with respect to the choice of problem instance, a set of integer-valued Sherrington-Kirkpatrick Ising problems are consider with range 1 (SK1), which is equivalent to a set of MAX-CUT problems with binary-signed edge weights. FIG. 6, shows the distribution of Tₛₐₘₚ(σ) over 50 SK1 problems, where for concreteness is chosen to be the first lexicographic configuration that gives the ground-energy of the problem. As shown, there is a spread in the required sampling time among problem instances, the distributions can be well-characterized by means and medians which show a clear monotonic decrease with decreasing decay time. Interestingly, this scaling persists to very low decay times on the order of T_{decay}˜1. In fact, for this problem size, performance only saturates and degrades at T_{decay}˜0.2, which, for this parameter set, is the point at which the roundtrip attenuation begins to exponentially approach unity (e.g., Rₗₒₛₛ˜1-e^{-Tdecay}) as a function of T_{decay}. At this point, the sensitivity of the system to system parameters preclude any additional significant gains in reducing the sampling time. The fact that the sampling performance continues to improve into the low-finesse regime is a key motivation for the development of our discrete-time Gaussian model.

### Sampling in Alternative Models of MFB-CIM

Although the focus thus far has been on developing a general model for the MFB-CIM in the Gaussian-state approximation and studying the dynamical role of quantum noise in its conventional operation (with parametric gain, homodyne measurement/feedback, measurement backaction, and gain saturation), it is also useful to consider alternative models or modes of operation which may be conceptually simpler or easier to implement experimentally. Of particular interest is to relate our quantum-based model to more classically-oriented formulations of CIMs, such as those based on coherent-state feedback networks without nonlinearity [Clements], or those based on deterministic nonlinear dynamics (with no quantum noise and only a random initial condition) which have proven to be fruitful models in which to study the roles of feedback and nonlinearity for CIM combinatorial optimization [45,47].

Thus, MFB-CIM with nonpositive parametric gain may be useful. Conventionally, the MFB-CIM is operated with parametric gain, i.e., the pump parameter r>0. However, the sampling performance for r≤0 may be explored, with the case of r=0 being especially experimentally interesting due to not requiring a pump source. Such a modification is straightforwardly accommodated within the general Gaussian model, so its performance can be directly compared against the conventional r>0 case, with gain saturation, quantum noise, and so on held fixed.

Furthermore, MFB-CIM without nonlinear crystal may be analyzed that is a MFB-CIM without optical nonlinearity by setting ετₙ₁=0, resulting in a “coherent-state” MFB-CIM, as squeezing never occurs. This model has previously been studied in Ref. [35] in the context of combinatorial optimization (also via a discrete-time formulation), whereas its performance for Ising sampling may be investigated. Since the resulting system has linear dynamics, the Gaussian formalism applies exactly and is an efficient representation of the quantum state throughout the dynamics.

A Mean-field MFB-CIM with injected measurement noise is a common approach to studying open-dissipative optical systems with weak single-photon nonlinearities is to neglect quantum noise altogether by taking a mean-field or classical limit, resulting in c-number continuous-time differential equations. This limit can be taken and motivated for our Gaussian MFB-CIM model as well, producing not only the usual continuous-time mean-field models for the MFB-CIM [45, 46] but also a new discrete-time model for this mean-field limit as well. However, to study sampling performance in this limit, an alternative noise source in the mean-field model is needed. For this purpose, fixed-variance Gaussian-distributed noise (limiting to white noise at the continuous-time limit) was injected in the measurement-and-feedback step [48]; such an extrinsic noise source can correspond, for example, to classical Johnson noise in the detector or to a random signal intentionally generated by the FPGA circuit (e.g., via a pseudorandom number generator).

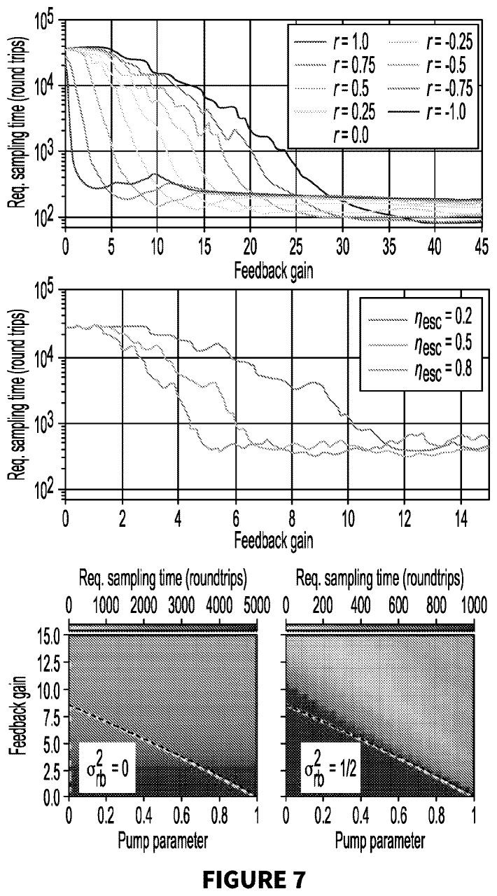

In FIG. 7(a), the required sampling time as a function of the feedback gain is shown over a range of pump parameters r, including r≤0, for the previously considered case of T_{decay}=4 and η_{esc}=0.2 from FIG. 5. (For r≥0, these lines are simply vertical slices of the upper left panel of FIG. 5.) Surprisingly, performance is quite comparable over a wide range of pump parameters with negative r, corresponding to parametric deamplification, giving slightly better performance at the expense of requiring higher feedback gain to overcome the deamplification. Generally, for sufficiently large feedback gain, there is always a robust region over which acceptable sampling performance is obtained, but for r>0, there is also a “sweet spot” at lower feedback gain where the stochastic noise due to anti-squeezing can allow for efficient sampling with lower feedback gain. Below, two operational modes, r>0 and r<0 are explored and scale to larger problem instances.

The second model where the non-linear crystal is removed from the MFB-CIM is explored in which ετₙ₁=0 (so nₛₐₜ=∞) which eliminates the need to integrate (16) and (17) for the crystal propagation each roundtrip. There is also no longer a pump parameter, leaving just the feedback gain parameter α in addition to T_{decay} and η_{esc}. Note that without the nonlinear saturation, the system is unstable once the feedback gain exceeds the roundtrip attenuation due to loss and out-coupling, but because our sampling metric (50) only involves the sign of the homodyne result, the metric is unaffected so long as the simulation is terminated before numerical overflow. In FIG. 7(b), the required sampling time is shown for this linear MFB-CIM for N_{decay}=4, and the performance also improves past a certain threshold, which obtains at smaller values of feedback gain compared with the nonlinear MFB-CIM. However, the required times for sampling are greater than that of the nonlinear MFB-CIM by at least a factor of two. This observation suggests that the nonlinear saturation plays an important role in embedding the Ising problem into the dynamics of the MFB-CIM, consistent with the findings of Ref. [47].

While the former two cases are straightforward to address within our model, the third approach involves taking a mean-field limit, which we can motivate as follows. For simplicity, the limit is illustrated using the continuous-time Gaussian-state EOMs (27), although by using the exact mapping detailed above, the procedure for the discrete-time version can be similarly derived. To take the mean-field limit, a classical mean-field coordinate may be defined \tilde{q}ᵢ=\sqrt{g/κ}(\tilde{q}ᵢ) in which case (27) can be written as

$$\frac{d {\tilde{q}}_{i}}{dt} = ( p - κ - γ ) {\tilde{q}}_{i} - \frac{κ}{2} {\tilde{q}}_{i}^{3} + λ {\sum }_{j} {J}_{ij} {\tilde{q}}_{j} + \sqrt{g} [ 2 ( 〈 δ {\tilde{q}}_{i}^{2} 〉 - \frac{1}{2} ) {ξ}_{i} + \frac{λ}{κ} {\sum }_{j} {J}_{ij} {ξ}_{j} ] \qquad ( 51 a )$$

$$\frac{d 〈 δ {\hat{q}}_{i}^{2} 〉}{dt} = 2 p 〈 δ {\hat{q}}_{i}^{2} 〉 - 2 ( γ + κ ) ( 〈 δ {\hat{q}}_{i}^{2} 〉 - \frac{1}{2} ) - 4 κ ( 〈 δ {\hat{q}}_{i}^{2} 〉 - \frac{1}{2} ) . \qquad ( 51 b )$$

The limit of small single-photon non-linearities where g is small is considered. As long as \tilde{q}ᵢ is finite, the dynamics of [symbol] δ\tilde{q}ᵢ² [symbol] are bounded, so the noise terms in the second line of (51a) scale overall as \sqrt{g}, thus becoming negligible compared to the other terms of (51a) in the limit g<<κ,ρ,γ,λ. It also follows that [symbol] \tilde{q}ᵢ [symbol] >> [symbol] δ\tilde{q}ᵢ² [symbol] , so that the latter can be neglected, upon which the dynamics are completely characterized by \tilde{q}ᵢ, i.e., the EOMs are simplified to

$$\frac{d {\tilde{q}}_{i}}{d t} = ( p - κ - γ ) {\tilde{q}}_{i}^{3} - \frac{κ}{2} {\tilde{q}}_{i}^{3} + λ {\sum }_{j} {J}_{ij} {\tilde{q}}_{j .} \qquad ( 52 )$$

The numerical simulations we use to study sampling performance in this limit uses the discrete-time version of the above limit, which involve the same arguments as above. When studying mean-field dynamics, it is standard procedure to introduce a small, random initial condition to avoid unstable fixed points of the dynamics, so \tilde{q}ᵢ(0)=σᵢ\tilde{l}ᵢ where \tilde{q}ᵢ is fixed to 10⁻³ and σᵢ is uniformly sampled from ±1. The main requirement is that q₀ be sufficently small to avoid undue transients in the mean-field simulations, and while this randomness may, in some contexts, be given a quantum-noise interpretation (as quantum noise has variance ˜g/κ in these mean-field coordinates), this is not a physical necessity and it can simply originate from a small random classical seed, for example.

Because [symbol] δ\hat{q}ᵢ² [symbol] /\tilde{q}ᵢ˜g/κ→0, the fluctuations in the homodyne measurement results \tilde{w}ᵢ=\sqrt{g/κ}wᵢ also vanish in this limit, and \tilde{w}ᵢ→rₒᵤₜ\tilde{q}ⱼ. The internal cavity state, represented by simply \tilde{q}ᵢ, experiences no backaction (e.g., amplitude shift) upon measurement, and the feedback signal

\tilde{υ}ᵢ=J₀ΣⱼJᵢⱼ\tilde{w}ⱼ→J₀ΣⱼJᵢⱼrₒᵤₜ\tilde{q}ᵢ

becomes a deterministic function of the internal state. To restore stochasticity in the measurement feedback loop while still retaining the classical character of the model, the feedback term (21) may be replaced with

$${\tilde{v}}_{i} = {J}_{0} {\sum }_{j = 1}^{N} {J}_{ij} ( {\tilde{w}}_{j} + {z}_{j} ) , \qquad ( 53 )$$

where zⱼ˜ [symbol] (0, σₜₕ), representing the injection of classical Gaussian-distributed noise into the measurement.

In FIG. 7(c), the required sampling time is shown as a function of pump parameter and feedback gain for this mean-field model for N_{decay}=4 and η_{esc}=0.2. The left panel shows the performance of the mean-field model with σ_{fb}²=0 conventionally used to study combinatorial optimization in the classical CIM, which is significantly less efficient at sampling than the Gaussian model. On the other hand, setting σ_{fb}²=½ in the right panel recovers much of the sampling performance of the Gaussian model. This result suggests that efficient sampling in the MFB-CIM, while naturally accessible via quantum noise, can nevertheless be largely emulated by classical noise interacting with weak single-photon nonlinearities. Of course, this comparable performance comes at a cost: whereas |υᵢ|² and |β|² represent the approximate number of photons (i.e., quanta of energy) required to operate the feedback and pump terms of the Gaussian MFB-CIM, respectively, these energy costs are scaled by a factor of κ/g into the large-photon-number regime for the mean-field MFB-CIM, and this is before accounting for the energy consumption, if any, associated with generating the random classical-scale noise zᵢ. Thus, despite the promising sampling performance predicted by the mean-field MFB-CIM model, it remains the case that the Gaussian model is the more relevant model for studying the “standard quantum limit” of the MFB-CIM.

It is noted that both the coherent-state linear model and the mean-field nonlinear model explicitly exclude, each in their own way, the quantum correlations between the internal and out-coupled pulses (i.e., [symbol] \hat{q}ᵢ\hat{q}ₕ [symbol] can be neglected). This means that these latter two models do not feature the measurement-induced shifts in the mean and variance of the internal state as described by (9) in the Gaussian model. Further research into the dynamical and operational differences among these models could help elucidate the role such quantum correlations play in the mechanics of the CIM.

### Scaling Estimates for Sampling Performance

The scaling of the sampling performance of the discrete-time MFB-CIM with respect to problem size may be analyzed and focused on verifying that the different insights and results above derived from studying small and particular problem instances can generalize to various as well as large problem instances. The discussion may be around a particular Ising problem class with a large number of ground and first-excited states, and evaluate the performance of the MFB-CIM with multiple instances of this problem class for every given problem size. The relationship between sampling performance and the hardness associated with a given problem matrix is also reviewed with studies how the performance of various alternative models of the MFB-CIM introduced in scales.

This analysis may employ a more stringent metric than the (previously employed) required sampling time Tₛₐₘₚ to characterize the sampling performance of the MFB-CIM. This is because the required sampling time assumes that the machine can be stopped at an optimal time, which while useful for characterizing the potential computational power of the MFB-CIM, may not be representative of the actual performance of the MFB-CIM in an experimental setting. The sampling time Tₐₗₗ is defined as the required number of trajectories to sample all ground and first excited state multiplied by the constant number of round-trip per trajectory. This definition is well suited to the experimental procedure where each trajectory is simply run for a pre-chosen, fixed number of round-trips Tₛᵢₘ, upon which Tₐₗₗ gives the time such an experiment would need to run for. This choice is conservative in the sense that utilizing more sophisticated experimental heuristics for predicting when to stop each trajectory could lead to faster sampling than given by Tₐₗₗ (and closer to the required sampling time). Finally, the time T_{any} is studied to sample any one of the ground or first-excited configurations, which is similarly defined as the number of trajectories required to sample any of the ground or first excited state multiplied by Tₛᵤₘ.

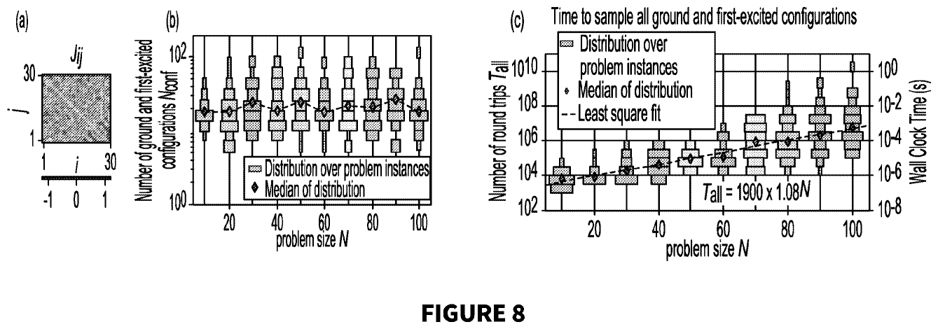

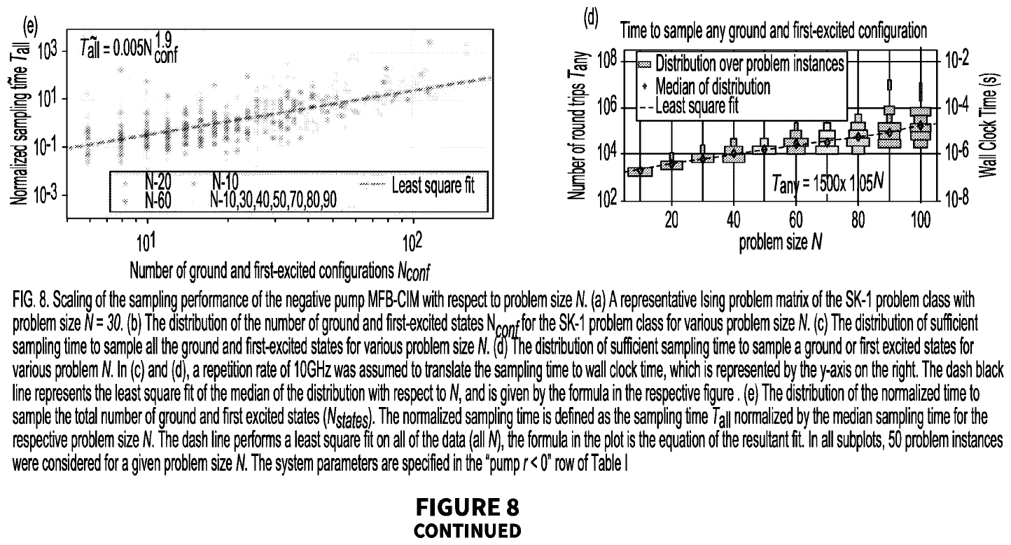

FIG. 8 shows how the sampling performance of the MFB-CIM scales with problem size N. For any given N, 50 problem instances are considered from the SK1 problem class. A representative instance of this problem class can be found in FIG. 8(a), which shows that the non-diagonal elements of the problem matrix Jᵢⱼ ∈ ±1. As shown in FIG. 8(b), this problem class has a large total number of degenerate ground and first-excited configurations N_{conf} which is beneficial for evaluating sampling performance. FIG. 8(c) shows the distribution of the sampling time Tₐₗₗ for various problem sizes. The numerical study is conducted for the negative-pump (r<0) MFB-CIM model which was found to perform well for the N=16 instance studied above. The various parameters associated with the model are specified in Table I.

TABLE I
System parameters associated with the various alternative
CIM-schemes for the large N numerical study conducted in
Sec. IV. For all simulations, Tₛᵢₘ = 50N_{decay}, and nₛₐₜ = 200 for all
simulations except the case of ϵ = 0, where it is undefined.

| | N_{decay} | α | γ | η_{esc} |
|---|---|---|---|---|
| Positive pump | 4 | 40 + 10z | −0.8 + 0.08z | 0.2 |
| No pump | 4 | 30 + 5z | 0 | 0.5 |
| Negative pump | 1 | 4 + 0.6z | 0.8 + 0.05z | 0.5 |
| No nonlinearity | 2 | 10 + 2z | — | 0.5 |

As shown in the table, some key parameters are stochastically varied from trajectory to trajectory in order to account for variations in the dynamical threshold of the MFB-CIM, leading to some problem instances being stuck (which would be easy to detect and correct experimentally). FIG. 8(c) also shows the wall clock time required to sample all N_{conf} states assuming a repetition rate of 10 GHz. In particular, it shows that for a relatively large problem size of N=100, all the states can be sampled within 0.6 ms; for future work, it may be interesting to perform more thorough benchmark studies for how these wall clock times compare to those attained by contemporary algorithms running on conventional digital hardware. Similarly, FIG. 8(d) shows the distribution of sampling time T_{any} for any ground or first-excited configuration. It is noted that T_{any} scales exponentially with respect to problem size N, which is consistent with prior results in the literature [7]. Studying the scaling of T_{any} against that of Tₐₗₗ provides a better understanding of the overhead incurred in simultaneously sampling multiple configurations of interest; the difference in the base of the exponent (1.05 vs. 1.08) suggests that though the overhead scales exponentially, the penalty (with a base of the exponent of ˜1.028) is not especially high. Finally, in FIG. 8(e), the scaling of the normalized sampling time \tilde{T}ₐₗₗ (normalized by the median Tₐₗₗ for each N) with respect the number of sampling configurations N_{conf}. There is correlation between the two quantities and that the normalized sampling time scales approximately quadratically with respect to N_{conf}.

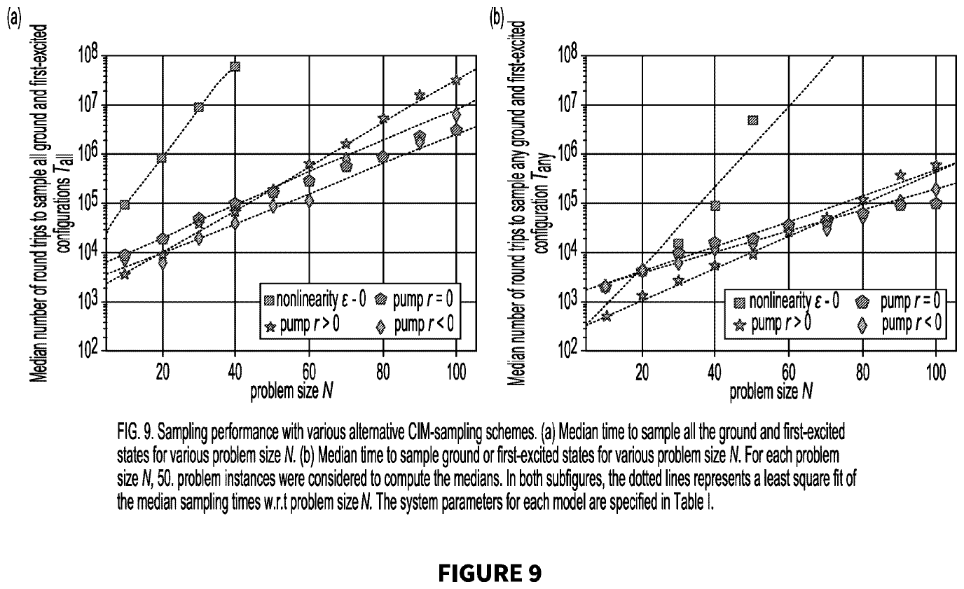

Having studied the details of how the sampling performance of the MFB-CIM scales in a particular mode of operation, how different alternative modes of operation perform with respect to each other are reviewed. FIG. 9 shows how the median time to sample all states Tₐₗₗ or any state T_{any} scales with N for the different alternative models considered above [49]. Due to the large parameter space present in the MFB-CIM, the parameters used for each model, as listed in Table I, were heuristically chosen by optimizing over a small set (order 10) of variations around the optimal parameters found above for N=16. The results confirm that the linear model performs worst and thus only coherent-state measurement noise without nonlinearity cannot adequately explain the sampling performance of the MFB-CIM. More interestingly, it also shows that setting the pump to be negative or even zero results in sampling performance that scales better for sampling both all states as well as any state. Given the experimental ease of not having to pump the system, the r=0 results are especially relevant for future MFB-CIM experiments.

FIG. 11 illustrates a computer implements embodiment of a MFD-CIM system for efficient sampling. Instead of developing quantum computing hardware using superconducting circuits, trapped ions, quantum dots etc. such as that shown in FIG. 1, the system 1100 uses a computer and theories as described above. The model and method may be programmed into a programmable circuit 1102 that may be, for example, existing digital electronic circuits such as Field Programmable Gate Array (FPGA) or Application Specific Integrated Circuit (ASIC). This approach does not need an expensive quantum hardware but readily run quantum computing in cyber space with relatively cheap and reliable silicon integrated circuits. In other implementations, the method can be instantiated in a CPU or a GPU where the processing core of either of these would execute instructions that implement the method disclosed in FIG. 10.

In the example implementation of the system shown in FIG. 11, the programmed programmable circuit 1102 may be part of a computer system that executes the method on the programmable circuit 1102 to perform the exemplary efficient sampling method discussed above. The computer system may have a display 1104 and a chassis 1106 that houses at least one processor 1108 and memory 1110 from which may be executed by the processor 1108 a plurality of lines of instructions to interface to the programmable circuit 1102 and perform the methods stored in the programmable circuit 1102. The chassis may also house the programmable circuit 1102. The exemplary computer system in FIG. 11 may also have the typical input/output devices such as a display, the keyboard and/or mouse. Alternatively, the computer system may be a server computer, a cloud computing resource, etc. that can execute the method processes on the programmable circuit 1102 (of other digital storage) to perform the exemplary combinatorial quantum inspired optimizing methods discussed below.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers,. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

### REFERENCES

[1] A. Lucas, Front. Phys. 2, 5 (2014).
[2] S. G. Brush, Rev. Mod. Phys. 39, 883 (1967).
[3] F. Barahona, J. Phys. A 15, 3241 (1982).
[4] M. Johnson, M. Amin, S. Gildert, T. Lanting, F. Hamze, N. Dickson, R. Harris, A. Berkley, J. Johansson, P. Bunyk, E. Chapple, C. Enderud, J. Hilton, K. Karimi, E. Ladizinsky, N. Ladizinsky, T. Oh, I. Perminov, C. Rich, M. Thom, E. Tolkacheva, C. Truncik, S. Uchaikin, J. Wang, B. Wilson, and G. Rose, Nature 473, 194 (2011).
[5] S. Boixo, T. F. R nnow, S. V. Isakov, Z. Wang, D. Wecker, D. A. Lidar, J. M. Martinis, and M. Troyer, Nat. Phys. 10, 218 (2014).
[6] A. Marandi, Z. Wang, K. Takata, R. L. Byer, and Y. Yamamoto, Nat. Photon. 8, 937 (2014).
[7] P. L. McMahon, A. Marandi, Y. Haribara, R. Hamerly, C. Langrock, S. Tamate, T. Inagaki, H. Takesue, S. Utsunomiya, K. Aihara, R. L. Byer, M. M. Fejer, H. Mabuchi, and Y. Yamamoto, Science 354, 614 (2016).
[8] T. Inagaki, Y. Haribara, K. Igarashi, T. Sonobe, S. Tamate, T. Honjo, A. Marandi, P. L. McMahon, T. Umeki, K. Enbutsu, O. Tadanaga, H. Takenouchi, K. Aihara,K.-i. Kawarabayashi, K. Inoue, S. Utsunomiya, and H. Takesue, Science 354, 603 (2016).
[9] T. Inagaki, K. Inaba, R. Hamerly, K. Inoue, Y. Yamamoto, and H. Takesue, Nat. Photon. 10, 415 (2016).
[10] I. Mahboob, H. Okamoto, and H. Yamaguchi, Sci. Adv. 2, e1600236 (2016).
[11] T. Wang and J. Roychowdhury, in Unconventional Computation and Natural Computation, edited by I. McQuillan and S. Seki (Springer International Publishing, 2019) pp. 232-256.
[12] D. Pierangeli, G. Marcucci, and C. Conti, Phys. Rev. Lett. 122, 213902 (2019).
[13] Y. Okawachi, M. Yu, J. K. Jang, X. Ji, Y. Zhao, B. Kim, M. Lipson, and A. Gaeta, Nat. Commun. 11, 4119 (2020).
[14] J. Chou, S. Bramhavar, S. Ghosh, and W. Herzog, Sci. Rep. 9, 14786 (2019).
[15] F. Cai, S. Kumar, T. Van Vaerenbergh, X. Sheng, R. Liu, C. Li, Z. Liu, M. Foltin, S. Yu, Q. Xia, J. J. Yang, R. Beausoleil, W. D. Lu, and J. P. Strachan, Nat. Electron. 3, 409 (2020).
[16] Z. Zhu, A. J. Ochoa, and H. G. Katzgraber, Phys. Rev. E 99, 063314 (2019).
[17] G. E. Hinton, Neural Comput. 14, 1771 (2002).
[18] R. Salakhutdinov, A. Mnih, and G. Hinton, in ACM Int. Conf. Proceeding Ser., Vol. 227 (ACM Press, New York, New York, USA, 2007) pp. 791-798.
[19] A. Perdomo-Ortiz, M. Benedetti, J. Realpe-Gomez, and R. Biswas, Quantum Sci. Technol. 3, 030502 (2018).
[20] R. S. Bohacek, C. McMartin, and W. C. Guida, Med. Res. Rev. 16, 3 (1996).
[21] V. Lounnas, T. Ritschel, J. Kelder, R. McGuire, R. P. Bywater, and N. Foloppe, Comput. Struct. Biotechnol. J. 5, e201302011 (2013).
[22] K. Ogata, T. Isomura, S. Kawata, H. Yamashita, H. Kubodera, and S. J. Wodak, Molecules 15, 4382 (2010).
[23] H. Sakaguchi, K. Ogata, T. Isomura, S. Utsunomiya, Y. Yamamoto, and K. Aihara, Entropy 18, 365 (2016).
[24] Z. Bian, F. Chudak, R. Israel, B. Lackey, W. G. Macready, and A. Roy, Front. Phys. 2, 56 (2014).
[25] Z. Bian, F. Chudak, R. B. Israel, B. Lackey, W. G. Macready, and A. Roy, Front. ICT 3, 14 (2016).
[26] Y. Matsuda, H. Nishimori, and H. G. Katzgraber, J. Phys. Conf. Ser. 143, 012003 (2009).
[27] S. Mandra, Z. Zhu, and H. G. Katzgraber, Phys. Rev. Lett. 118, 070502 (2017).
[28] M. S. Konz, G. Mazzola, A. J. Ochoa, H. G. Katzgraber, and M. Troyer, Phys. Rev. A 100, 030303 (2019).
[29] Y. Yamamoto, T. Leleu, S. Ganguli, and H. Mabuchi, Appl. Phys. Lett. 117, 160501 (2020).
[30] S. L. Braunstein and P. van Loock, Rev. Mod. Phys. 77, 513 (2005).
[31] C. M. Caves, Phys. Rev. D 26, 1817 (1982).
[32] H. Wiseman and G. Milburn, Quantum Measurement and Control (Cambridge University Press, 2010).
[33] S. Kako, T. Leleu, Y. Inui, F. Khoyratee, S. Reifenstein, and Y. Yamamoto, Adv. Quantum Technol. 3, 2000045 (2020).
[34] Y. Inui and Y. Yamamoto, Phys. Rev. A 102, 062419 (2020).
[35] W. R. Clements, J. J. Renema, Y. H. Wen, H. M. Chrzanowski, W. S. Kolthammer, and I. A. Walmsley, Phys. Rev. A 96, 043850 (2017).
[36] A. Yamamura, K. Aihara, and Y. Yamamoto, Phys. Rev. A 96, 053834 (2017).
[37] C. Weedbrook, S. Pirandola, R. Garc a-Patr on, N. J. Cerf, T. C. Ralph, J. H. Shapiro, and S. Lloyd, Rev. Mod. Phys. 84, 621 (2012).
[38] G. Adesso, S. Ragy, and A. R. Lee, Open Syst. Inf. Dyn. 21, 1440001 (2014).
[39] J. B. Brask, arXiv:2102.05748 [quant-ph].
[40] I. G. Vladimirov and I. R. Petersen, arXiv:1202.0946 [quant-ph].
[41] C. W. Gardiner and M. J. Collett, Phys. Rev. A 31, 3761 (1985).
[42] H. M. Wiseman and G. J. Milburn, Phys. Rev. A 47, 642 (1993).
[43] S. Lloyd, Science 273, 1073 (1996).
[44] J. J. Sakurai and J. Napolitano, Modern Quantum Mechanics, 2nd ed. (Cambridge University Press, 2017).
[45] Z. Wang, A. Marandi, K. Wen, R. L. Byer, and Y. Yamamoto, Phys. Rev. A 88, 063853 (2013).
[46] T. Leleu, Y. Yamamoto, P. L. McMahon, and K. Aihara, Phys. Rev. Lett. 122, 040607 (2019).
[47] M. C. Strinati, L. Bello, E. G. D. Torre, and A. Pe'er, arXiv:2011.09490 [cond-mat.stat-mech].
[48] D. Pierangeli, G. Marcucci, D. Brunner, and C. Conti, Nanophotonics 9, 4109 (2020).
[49] We do not consider the classical mean-eld model here as realizing those models in experiment requires more energy, making the comparison implicitly unfair.
[50] Y. Inui and Y. Yamamoto, arXiv:2009.10328 [physics.optics].

1. A system of sampling of ground-state and low-energy Ising configurations using a measurement-feedback-based coherent Ising machine (MFB-CIM), the system comprising:
a non-linear optical parametric oscillator configured to be pumped with internal pulses, the non-linear optical parametric oscillator causing a non-linear gain saturation of the internal pulses using a discrete-time Gaussian-state quantum model; and
a linear measurement feedback loop configured to perform homodyne measurements of the internal pulses with the non-linear gain saturation, the linear measurement feedback loop further comprising an electronic circuit configured to perform matrix vector multiplication based on the homodyne measurements.

2. The system of claim 1, wherein the non-linear optical parametric oscillator comprises a non-linear crystal.

3. The system of claim 1, wherein the electronic circuit is further configured to compute a feedback pulse for the non-linear optical parametric oscillator based on the homodyne measurements.

4. The system of claim 3, wherein an interaction between at least one of the internal pulses and the feedback pulse causes the system to steer toward lower energy Ising spin configurations.

5. The system of claim 3, further comprising a coherent injector configured to inject the feedback pulse to the non-linear optical parametric oscillator.

6. The system of claim 1, further comprising an outcoupler configured to couple the internal pulses to the linear measurement feedback loop.

7. The system of claim 1, wherein bistable phase states of the non-linear optical parametric oscillator due to the pumping of the internal pulses are configured to encode Ising spins.

8. The system of claim 1, comprising N non-linear optical parametric oscillators configured to model an Ising coupling matrix J.

9. The system of claim 8, comprising N linear measurement feedback loops coupled to corresponding to the N non-linear optical parametric oscillators, wherein each of the N non-linear optical parametric oscillators causes corresponding non-linear gain saturation of corresponding internal pulses using the discrete-time Gaussian-state quantum model.

10. The system of claim 1, wherein the electronic circuit comprises a field programmable gate array.

11. A method for sampling of ground-state and low-energy Ising configurations using a measurement-feedback-based coherent Ising machine (MFB-CIM), the method comprising:
pumping internal pulses to a non-linear optical parametric oscillator;
causing, by the non-linear optical parametric oscillator, a non-linear gain saturation of the internal pulses using a discrete-time Gaussian-state quantum model
performing, by a linear measurement feedback loop, homodyne measurements of the internal pulses with the non-linear gain saturation; and
performing, by an electronic circuit of the linear measurement feedback loop, matrix vector multiplication based on the homodyne measurements.

12. The method of claim 11, wherein the non-linear optical parametric oscillator comprises a non-linear crystal.

13. The method of claim 11, further comprising:
computing, by the electronic circuit, a feedback pulse for the non-linear optical parametric oscillator based on the homodyne measurements.

14. The method of claim 13, wherein an interaction between at least one of the internal pulses and the feedback pulse causes a steering toward lower energy Ising spin configurations.

15. The method of claim 13, further comprising:
injecting, by a coherent injector, the feedback pulse to the non-linear optical parametric oscillator.

16. The method of claim 11, further comprising:
coupling, by an outcoupler, the internal pulses to the linear measurement feedback loop.

17. The method of claim 11, wherein bistable phase states of the non-linear optical parametric oscillator due to the pumping of the internal pulses encode Ising spins.

18. The method of claim 11, wherein the MFB-CIM comprises N non-linear optical parametric oscillators modeling an Ising coupling matrix J.

19. The method of claim 18, wherein the MFB-CIM comprising N linear measurement feedback loops coupled to corresponding to the N non-linear optical parametric oscillators, wherein each of the N non-linear optical parametric oscillators causes corresponding non-linear gain saturation of corresponding internal pulses using the discrete-time Gaussian-state quantum model.

20. The method of claim 11, wherein the electronic circuit comprises a field programmable gate array.
